(19) United States
(12) Patent Application Publication
(10) Pub. No.: US 2024/0238908 A1
(43) Pub. Date: Jul. 18, 2024

(54) TRANSMISSION POLE MANUFACTURING LINE AND METHOD OF MANUFACTURING

(71) Applicant: NUCOR TOWERS & STRUCTURES INC, West Hazleton, PA (US)

(72) Inventors: Paul W. Johnson, III, Fort Mill, SC (US); Robert A. Robinson, Hazletownship, PA (US); Travis Marshall Fuhrman, Simpsonville, KY (US); Gregory Earl Noll, Chattanooga, TN (US); Jaroslav Tyman, Apison, TN (US); Brent Eugene Boxall, LaFayette, GA (US); Mell Tex Sammons, Soddy Daisy, TN (US); Michele Di Tullio, Spinazzola (IT); Nicola Di Tullio, Spinazzola (IT)

(73) Assignee: NUCOR TOWERS & STRUCTURES INC, West Hazleton, PA (US)

(21) Appl. No.: 18/413,550

(22) Filed: Jan. 16, 2024

Related U.S. Application Data
(60) Provisional application No. 63/439,181, filed on Jan. 16, 2023.

(51) Int. Cl. B23K 31/02; B23K 9/02; B23K 37/02

(52) U.S. Cl. CPC B23K 31/02; B23K 9/02; B23K 37/0252

(57) ABSTRACT

A pole manufacturing line with a shell forming apparatus in which material blanks (e.g., steel plates, sheets, or the like, other metals, composites, or other material) are cut into one or more shell blanks (e.g., different sizes for different types of poles), and the shell blanks are shaped into shaped shells (e.g., a single shell, half shells, tri-shell, quad shells, or the like). The pole manufacturing line has a shell assembly apparatus in which shells are supplied to a welding apparatus to create longitudinal seam welds in the shaped shells to form the poles, the poles are transported to one or more cells for straightening the pole, trimming the pole length, preparing the pole for components (e.g., base, flanges, supports, or other hardware) and welding the components to the pole.

### CROSS REFERENCE AND PRIORITY CLAIM UNDER 35 U.S.C. § 119

The present application for a patent claims priority to U.S. Provisional Patent Application Ser. No. 63/439,181 entitled “Transmission Pole Manufacturing Apparatus and Method of Manufacturing,” filed on Jan. 16, 2023, and assigned to the assignees hereof and hereby expressly incorporated by reference herein.

### FIELD

This application relates generally to the field of pole manufacturing, and more particularly to improvements to transmission pole manufacturing.

### BACKGROUND

Transmission poles are typically formed of one or more hollow steel tube portions. The tube portions may be tapered from one end to the other. Multiple tube portions may be coupled together to provide additional support for transmission lines that cross long spans (e.g., rivers, valleys, or the like). In some applications the hollow steel tubes may include additional material (e.g., concrete, composites, or the like) to add additional support to the hollow steel portions.

### BRIEF SUMMARY

Embodiments of the present disclosure a pole manufacturing lines having one or more apparatuses, which may comprise of a shell forming apparatus in which material blanks (e.g., steel plates, sheets, or the like, other metals, composites, or other material) are cut into one or more shell blanks (e.g., different sizes for different types of poles), and the shell blanks are shaped into shaped shells (e.g., a single shell, half shells, tri-shell, quad shells, or the like). The pole manufacturing line may have one or more additional apparatuses, which comprise a shell assembly apparatus in which shaped shells are supplied to a shell seam welding apparatus to create longitudinal seam welds in the shaped shell in order to form the seamed shells. The seamed shells (e.g., partial pole portions, or the like) are transported to one or more cells having one or more additional apparatuses that may straighten the seamed shells, trim the seamed shell length, prepare the seamed shell for components (e.g., flanges, supports, or other hardware) and weld the components to the seamed shell to form the pole (e.g., full pole, partial pole portion, or the like), as will be discussed in further detail herein. It should be understood that while the pole manufacturing line is described generally as having a shell forming apparatus that is used to form the shaped shells and a shell assembly apparatus that is used to assemble the shaped shells into the pole sections, the apparatuses, stations, cells, devices thereof, or the like described herein may be combined with each other, rearranged within the line, split out into other apparatuses, grouped in different apparatuses, or the like.

One embodiment of the invention comprises a pole manufacturing line for forming poles. The pole manufacturing line comprises a shell forming apparatus and a shell assembly apparatus. The shell forming apparatus comprises a blank cutting apparatus for forming a plurality of shell blanks from a material blank, and a shaping apparatus for forming a shaped shell from a shell blank. The shell assembly apparatus comprises a seam welding apparatus, a seamed shell cutting apparatus, and a component welding apparatus. The seam welding apparatus welds one or more seams of one or more shaped shells to form a seamed shell. The seamed shell cutting apparatus forms one or more apertures in the seamed shell or forms one or more ends of the seamed shell. The component welding apparatus welds one or more components to the seamed shell to form a pole.

In further accord with embodiments of the invention, the pole tapers from a wide end to a narrow end. The pole is at least a portion of a transmission pole, and one or more poles are used to form the transmission pole.

In other embodiments of the invention, the blank cutting apparatus forms two or more shell blanks from the material blank, and at least a first shell blank is in a first orientation that is in an opposite orientation from at least a second shell blank in a second orientation.

In still other embodiments of the invention, the shell forming apparatus further comprises a blank handling apparatus. The blank handling apparatus is configured to rotate the first shell blank from the first orientation to the second orientation. The second orientation locates a wide end and a narrow end of the shell blank for shaping by the shaping apparatus.

In yet other embodiments of the invention, the blank handling apparatus comprises a rotation apparatus. The rotation apparatus comprises a rotator table, a rotator carriage operatively coupled to the rotator table, and one or more rotator drive apparatuses operatively coupled to the rotator carriage. The one or more rotator drive apparatuses allow the rotator table to move laterally to receive or deliver the plurality of shell blanks in different lateral positions. The one or more rotator drive apparatuses allow the rotator table to move vertically to receive or deliver the plurality of shell blanks in different vertical positions. The one or more rotator drive apparatuses allow the rotator table to rotate the first shell blank in the first orientation to the second orientation.

In other embodiments of the invention, the shell forming apparatus further comprises a shell blank holding apparatus. The shell blank holding apparatus comprises a plurality of racks having two or more laterally spaced racks and two or more vertically spaced racks. The shell blanks having different attributes are stored in the plurality of racks.

In further accord with embodiments of the invention, the shell blank holding apparatus further comprises a feeder apparatus. The feeder apparatus comprises a feeder table, a feeder carriage, and one or more feeder drive apparatuses operatively coupled to the feeder carriage. The one or more feeder drive apparatuses allow the feeder table to move laterally to receive or deliver the plurality of shell blanks in different lateral positions. The one or more feeder drive apparatuses allow the feeder table to move vertically to receive or deliver the plurality of shell blanks in different vertical positions.

In other embodiments of the invention, the shaping apparatus comprises a plurality of shapers. The plurality of shapers operate independently or jointly to shape the plurality of shell blanks of different sizes into shaped shells of different sizes.

In still other embodiments of the invention, the shaping apparatus further comprises one or more sensors, and one or more shell blank handling apparatuses operatively coupled to the sensors. The one or more shell blank handling apparatuses position the shell blank with respect to the plurality of shapers based on the information from the one or more sensors captured from a shape of the shell blank or markings on the shell blank.

In yet other embodiments of invention, the shell assembly apparatus further comprises a shaped shell holding apparatus. The shaped shell holding apparatus comprises a plurality of racks having two or more laterally spaced racks and two or more vertically spaced racks. The plurality of shaped shells having different attributes are stored in the plurality of racks.

In other embodiments of the invention, the seam welding apparatus comprises an end support configured to be operatively coupled with the one or more shaped shells and an automated welder apparatus configured to weld the one or more seams of the one or more shaped shells. The end support pulls or pushes the one or more shaped shells past the automated welder.

In further accord with embodiments of the invention, the seam welding apparatus comprises one or more shell supports configured to support two or more shaped shells, and one or more shell mating apparatuses. The one or more shell mating apparatuses comprises one or more actuating mating members and one or more mating drive apparatuses operatively coupled to the one or more actuating mating members. The one or more actuating mating members are configured to move at least a first shaped shell to mate with at least a second shaped shell before seam welding. The seam welding apparatus further comprises one or more automated welders configured to weld the one or more seams of the two or more shaped shells.

In other embodiments of the invention, the seamed shell cutting apparatus comprises one or more shell cutting supports configured to support the seamed shell, one or more shell cutting tracks, one or more shell cutting carriages operatively coupled to the one or more shell cutting tracks, and one or more shell cutting robots operatively coupled to the one or more shell cutting carriages. The one or more cutting robots are moveable to form the one or more apertures in the seamed shell or form the one or more ends of the seamed shell.

In still other embodiments of the invention, the component welding apparatus comprises one or more flange supports configured to support one or more flanges, one or more component welding tracks, one or more component welding carriages operatively coupled to the one or more component welding tracks, and one or more component welding robots operatively coupled to the one or more component welding carriages. The one or more component welding robots are moveable to weld the one or more flanges to the one or more ends of the seamed shell.

In yet other embodiments of the invention, the component welding apparatus further comprises one or more holding robots operatively coupled to the one or more shell welding carriages. The one or more holding robots hold pole components to the seamed shell while the one or more shell welding robots weld the components to the seamed shell.

In other embodiments of the invention, the flange supports comprise one or more flange members, a plurality of clamps operatively coupled to the one or more flange members, and one or more clamp drive apparatuses operatively coupled to the one or more flange members and the plurality of clamps. The plurality of clamps extend and retract to hold a plurality of flanges having different sizes.

In further accord with embodiments of the invention, the pole manufacturing line of further comprises a controller system. The controller system comprises one or more memories storing computer-readable code, and one or more processors operatively coupled to the one or more memories. When executed, the computer-readable code is configured to cause the one or more processors to communicate with the blank cutting apparatus to form two or more shell blanks having one or more attributes and send the two or more blanks to a holding apparatus. Moreover, when executed the computer-readable code is configured to communicate with the shaping apparatus to form the shaped shell from the shell blank. Additionally, when executed the computer-readable code is configured to communicate with the seam welding apparatus to form one or more seam welds in the one or more seams of the one or more shaped shells. Furthermore, when executed the computer-readable code is configured to communicate with the shell cutting apparatus to form the one or more apertures or the one or more ends of the seamed shell. Additionally, when executed the computer-readable code is configured to communicate with the component welding apparatus to weld the one or more components to the seamed shell to form the pole.

In further accord with embodiments of the invention, the controller system is configured to control the shell forming apparatus and the shell assembly apparatus to optimize pole manufacturing to reduce waste and improve lead times.

Another embodiment of the invention comprises a method of forming poles using a pole manufacturing line. The method comprises forming a plurality of shell blanks from material blanks using a blank cutting apparatus and forming a plurality of shaped shells from the plurality of shell blanks using a shaping apparatus. The method further comprises welding seams of a plurality of single shaped shells or a plurality of multiple shaped shells to form a plurality of seamed shells using a seam welding apparatus. Moreover, the method comprises forming a plurality of apertures or a plurality of ends on the plurality of seamed shells using a cutting apparatus and welding a plurality of components to the plurality of shaped shells using a component welding apparatus.

To the accomplishment of the foregoing and the related ends, the one or more embodiments of the invention comprise the features hereinafter fully described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF DRAWINGS

The foregoing and other advantages and features of the invention, and the manner in which the same are accomplished, will become more readily apparent upon consideration of the following detailed description of the invention taken in conjunction with the accompanying drawings, which illustrate embodiments of the invention, and which are not necessarily drawn to scale, wherein:

FIG. 1 illustrates a block schematic view of a pole manufacturing line, in accordance with embodiments of the present invention;

FIG. 2 illustrates a schematic view of a network diagram for controlling the pole manufacturing line or the apparatuses thereof, in accordance with embodiments of the invention;

FIG. 3A illustrates a process flow for the assembly of a pole using a pole manufacturing line, in accordance with embodiments of the invention;

FIG. 3B illustrates a continuation of the process flow of FIG. 3A, in accordance with embodiments of the invention;

FIG. 4 illustrates a plan view of a material handling station of the pole manufacturing line, in accordance with embodiments of the present disclosure.

FIG. 5 illustrates a plan view of a blank handling apparatus and a shell blank cutting apparatus of the pole manufacturing line, in accordance with embodiments of the present disclosure.

FIG. 6 illustrates a plan view of a shell blank handling apparatus and a rotation apparatus of the pole manufacturing line, in accordance with embodiments of the present disclosure.

FIG. 7 illustrates a plan view of a holding apparatus for a pole manufacturing line for holding flat shell blanks and/or shaped shell blanks having different attributes, in accordance with embodiments of the present disclosure.

FIG. 8 illustrates a side view of a shaping apparatus for a pole manufacturing line for shaping flat shell blanks into shaped shell blanks having different attributes, in accordance with embodiments of the present disclosure.

FIG. 9A illustrates a plan view of a single shell seaming apparatus for a pole manufacturing line for forming a weld in the seam of a single shell to form a seamed shell, in accordance with embodiments of the present disclosure.

FIG. 9B illustrates a plan view of a multiple shell seaming apparatus for a pole manufacturing line for forming welds in two or more seams of two or more shells to form a seamed shell, in accordance with embodiments of the present disclosure.

FIG. 10A illustrates a plan view of cutting apparatus for a pole manufacturing line for preparing the seamed shell for receiving components, in accordance with embodiments of the present disclosure.

FIG. 10B illustrates a perspective view of a cutting apparatus for a pole manufacturing line for preparing the seamed shell for receiving pole components, in accordance with embodiments of the present disclosure.

FIG. 11A illustrates a plan view of a component welding apparatus for a pole manufacturing line for assembling pole components to the seamed shell, in accordance with embodiments of the present disclosure.

FIG. 11B illustrates a perspective view of a component welding apparatus for a pole manufacturing line for assembling pole components to the seamed shell, in accordance with embodiments of the present disclosure.

FIG. 11C illustrates a perspective view of a flange support of the component welding apparatus for supporting a pole flange, in accordance with embodiments of the present disclosure.

FIG. 11D illustrates a perspective view of a portion of a component welding apparatus for welding the components to the seamed shell, in accordance with embodiments of the present disclosure.

FIG. 11E illustrates a perspective view of a robotic welder for welding a flange to the end of the seamed shell and/or other components to the seamed shell, in accordance with embodiments of the present disclosure.

FIG. 11F illustrates a perspective view of an end effector of a holding and/or welding robot for welding the components to the seamed shell, in accordance with embodiments of the present disclosure.

FIG. 12 illustrates a perspective view of a transmission pole having multiple poles that is installed in the field, in accordance with embodiments of the present disclosure.

FIG. 13A illustrates a perspective view of a flange transport apparatus for transporting a pole in a horizontal position, in accordance with embodiments of the present disclosure.

FIG. 13B illustrates a perspective view of a flange transport apparatus for transporting a pole in a vertical position, in accordance with embodiments of the present disclosure.

### DETAILED DESCRIPTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

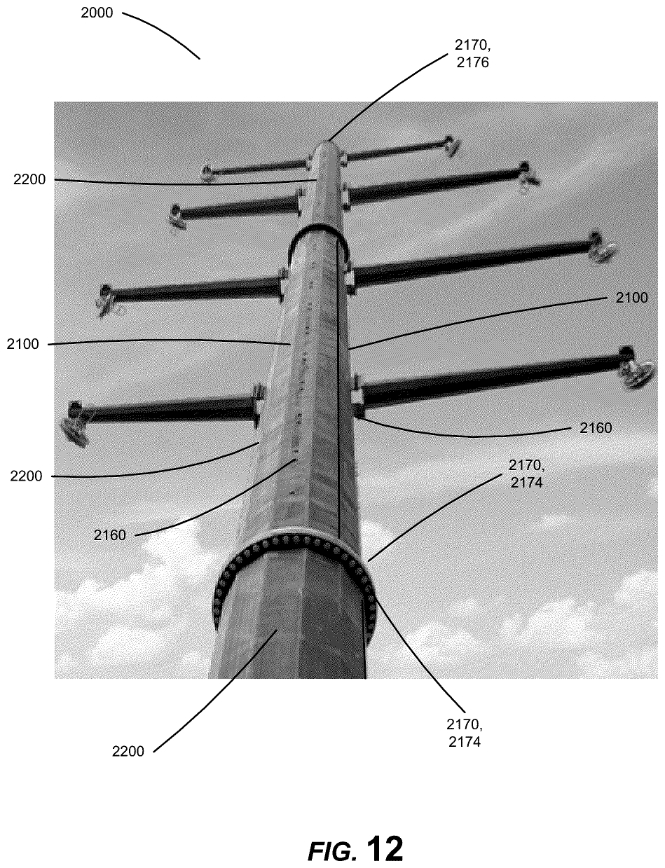

The present invention relates to an improved pole manufacturing line, apparatuses thereof, and method of assembling poles 2200 for formation into transmission towers 2000, as illustrated in FIG. 12. In particular, the improved pole manufacturing line is used to form poles 2200 (e.g., which may be single poles, portions of poles that are combined to form a larger pole, or the like) for transmission towers 2000. Moreover, while the term “seamed shell” and/or “pole” is used throughout this specification, it should be understood that the term “tube”, “shaft”, or the like may be interchangeable with the term “seamed shell” and/or “pole.” The pole manufacturing line equipment may include various stations, cells, apparatuses, or the like, as well as a controller for optimizing the manufacturing process in real-time based on materials, work in process, pole configurations (e.g., sizes, dimensions, components, component locations, or the like), manufacturing times of the apparatuses, or the like, as will be described in further detail herein.

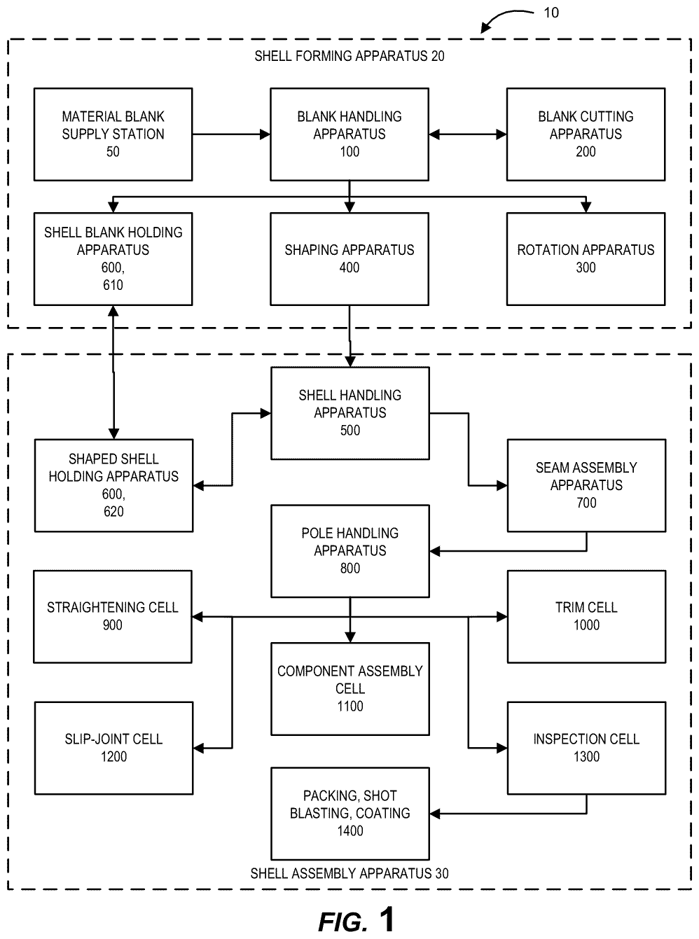

In some embodiments, the pole manufacturing apparatus 10 may comprise a shell forming apparatus 20 in which material blanks 2020 (e.g., steel plates, sheets, or the like, other metals, composites, or other material) are cut into one or more shell blanks 2050 (e.g., different sizes for different types of poles), and the shell blanks 2050 are shaped into shells 2100 (e.g., a single shell, half shells, tri-shells, quad shells, or the like), which may also be described as shaped shells 2100. The shell forming apparatus 20 will be described in further detail herein with respect to FIG. 1 and FIGS. 4 through 8. In some embodiments, the pole manufacturing apparatus 10 may further comprise a shell assembly apparatus 30 in which shaped shells 2100 are supplied to a seam assembly apparatus 700 (e.g., a seam welding apparatus 702, a fastener assembly apparatus, or other connection apparatus). The seam welding apparatus 702 may be a single seam welding apparatus 710 or a multiple seam welding apparatus 720 (e.g., used for single seams or multiple seams), both of which create longitudinal seam welds in the shaped shells 2100 to form the seamed shells 2150. After seaming, the seamed shells 2150 are transported to one or more cells that may be used for straightening the seamed shells 2150 and/or trimming the seamed shell length of the seamed seam shells 2150. Additionally, or alternatively the seamed poles 2150 may be transported for preparation of the assembly of components 2160 (e.g., flanges 2160—base flanges 2172, intermediate flanges 2174, and/or top flanges 2176, pole supports—clamps, vang supports for supporting vangs that hold transmission wires, fasteners, nuts, other connections, or the like), and thereafter, assembly (e.g., welding, or the like) of the components 2160 to the seamed shells 2150 to form the poles 2200. After the component assembly, the assembled poles 2200 may be further transported for inspecting the assembled poles 2200, and/or shot blasting, coating, and/or packaging the pole 2200 for shipping. It should be understood that while the pole manufacturing line 10 is described as having two sections, such as a shell forming apparatus 20 and a shell assembly apparatus 30, the apparatuses, stations, cells, or the like described herein may be combined with each other, rearranged within the line, split out to other apparatuses, grouped in different apparatuses, or the like.

The pole manufacturing line 10 will be described in further detail with respect to FIG. 1. As illustrated in FIG. 1, the pole manufacturing line 10, and in particular, the shell forming apparatus 20 may comprise a material blank supply station 50, a blank handling apparatus 100, a blank cutting apparatus 200, a shell blank rotation apparatus 300, and/or a shell shaping apparatus 400.

The material blank supply station 50 may comprise a staging area for a plurality of material blanks 2020. As noted above, the material blanks 2020 may comprise a supply of steel material, which may be in the form of steel sheets (e.g., from coils, or the like) or steel plates (e.g., when thicker material is required, or the like). The steel material (e.g., material blanks 2020, shell blanks 2050, shaped shells 2100, seemed shells 2150, and/or poles 2000, which will be described in further detail later), are illustrated in the figures as partially translucent; however, it should be understood that the steel material is solid and is only illustrated as partially translucent to better illustrate the equipment on which the steel material is located. The steel material within the material blank supply station may be stacked vertically, stacked horizontally, or the like, and as such may be provided as individual sheets (e.g., after being cut from coils, or the like), plates, or the like. It should be understood that while the material blanks are described as steel material (e.g., steel sheets, steel plates, or the like) the material blanks may be made of other materials. The steel material typically has a thickness of 3/16 to 1¼ inch; however, the steel material may have thickness that range between, overlap, or fall outside of these values. The steel material may have widths that range from 60 to 120 inches, and lengths up to 60 feet. The poles 2200 that are formed from the steel material, will typically have the same thicknesses and have lengths that range from 15 to 60 feet. However, it should be understood that the widths and/or lengths of the material blanks 2020, and thus the pole length, may have ranges that fall between these values, fall outside of these values, or overlap these values. Moreover, it should be understood that in some embodiments, the material blanks 2020 may be supplied to the pole manufacturing apparatus 10 through the use of cranes, conveyors, rollers, or other like equipment.

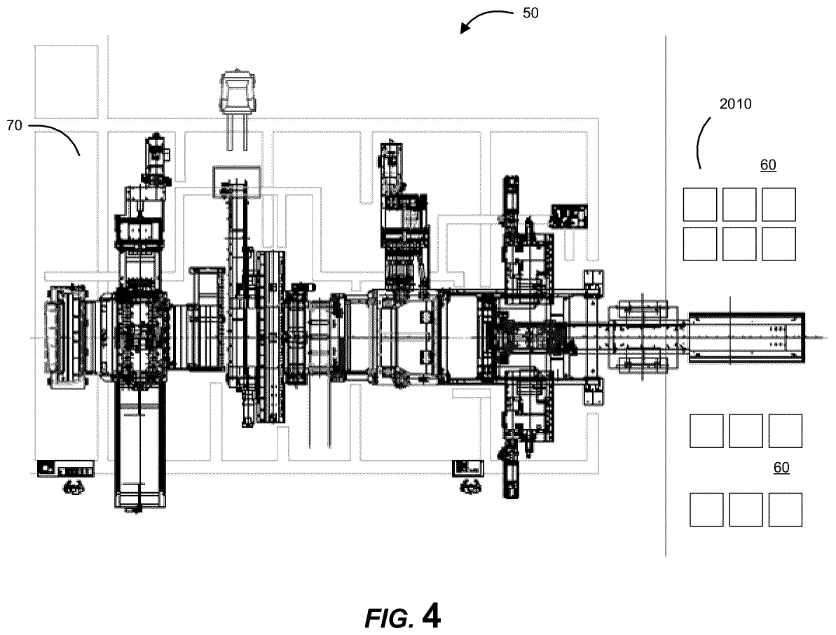

In some embodiments as illustrated in FIG. 4, the material blank supply station 50 may include a material supply station 60 in which steel material (e.g., plates or steel coils 2010) are located for future use. Moreover, the material blank supply station 50 may further include a material blank forming apparatus 70 in which the plates or sheets are pre-processed for downstream use. For example, the material blank forming apparatus 70 may receive the steel material (e.g., coils, or the like), unwind the coils, straighten the steel, and/or cut the steel material in material blanks 2010 of different sizes (e.g., lengths, widths—based on coil width used, or the like) depending on the downstream processing needs. Additionally, or alternatively, the material blank forming apparatus 70 may be used to process (e.g., straighten, cut, or the like) pre-formed plates into material blanks 2010 of different sizes (e.g., lengths, widths, or the like). Moreover, the material blank forming apparatus 70 may be used to prepare the surfaces of the material blanks for downstream processing. As such, the material blank forming apparatus 70 may be set up for forming material blanks from coils, plates, or may be able to handle both coils and plates.

As further illustrated in FIG. 1, the pole manufacturing line 10 may further comprise a material blank handling apparatus 100, which may be configured to transport (e.g., pick, move, deliver, or the like) one or more material blanks 2020 from the material blank supply station 50 to a blank cutting apparatus 200 (e.g., to a support thereof, such as a table, or the like thereof) wherein the material blanks 2020 will be cut into shell blanks 2050, as will be described in further detail below. The material blank handling apparatus 100 may comprise a crane that lifts the material blank 2020 and places it on a material blank support (e.g., horizontal table, jig in different orientations, or the like). The crane may comprise of a gantry crane and vacuum lift that is able to pick and move the material blanks (e.g., through suction member, moveable arms, clamps, chains, cables, gears, motors, or the like). While the material blank handling apparatus 100 is described as being a crane, alternatively or additionally, it may include conveyors, rollers, actuators (e.g., motors—electric or the like, hydraulic, pneumatic, or the like) that push, pull, or move the material blanks 2020 to the blank cutting apparatus 200. It should be understood that material handling sensors (e.g., light curtains, lasers, cameras, scanners, tags—NFC, RFID, and/or the like), may be utilized to identify the location of material blanks 2020 having different attributes (e.g., widths, lengths, thicknesses, material types—steel type, strengths, other steel properties, or the like), and a controller 1550 (as will be described herein) may communicate with the material blank handling apparatus 100 to pick different material blanks 2020 based on the sensor information, and then deliver the material blanks 2020 to one or more blank supports (e.g., rolling table, or the like) before or within the blank cutting apparatus 200.

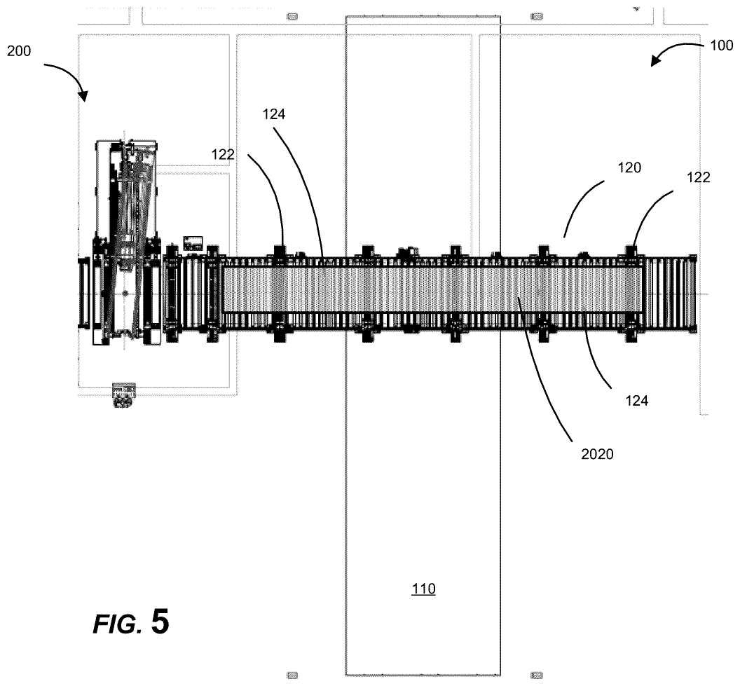

One embodiment of the material blank handling apparatus 100 and/or blank cutting apparatus 200 is illustrated in FIG. 5. It should be understood that in some embodiments the material blank handling apparatus 100 and blank cutting apparatus 200 may be separate apparatuses or may be combined as a single apparatus. The blank handling apparatus 100 may include an overhead crane 110 and/or a material blank rolling table 120 that may be used to transport the material blanks 2020 from the material supply station 50 to the blank cutting apparatus 200 for cutting. It should be understood that in some embodiments, the material blank rolling table 120 may include driven rollers 122, that are rotated for moving the material blanks 2020. The driven rollers 122 may be moved through the use of a drive assembly having one or more powered drives (e.g., motors—electric or the like, pneumatic, hydraulic, or the like), gears, chains, cables, belts, or the like. The material blank rolling table 120 may further comprise free rollers 124, which may rotate freely without being driven, as the material blanks 2020 are moved by the driven rollers 122.

The material blank cutting apparatus 200 may be used to form (e.g., cut, rip, separate, shear, slice, or the like) the material blank 2020 into shell blanks 2050. The one or more shell blanks 2050 created from the material blanks 2050 may be different sizes and shapes in order to create different shaped shells 2100, seamed shells 2150 formed the shaped shells 2100, and/or poles 2200 formed from the seamed shells 2150, wherein the poles 2200 have different sizes (e.g., different dimeters, different tapers, or the like) and to minimize the waste (e.g., minimize scrap material) from the material blanks 2020. The shell blanks 2050 may taper from one end 2054 (e.g., second end, wide end, or the like) to the opposing end 2052 (e.g., first end, narrow end, or the like), that is, the width may decrease between the edges from a second end 2054 to a first end 2052). As such, multiple shell blanks 2050 may be formed from a material blank 2020 in an alternating pattern (e.g., opposing pattern with wider ends adjacent to narrower ends) in order to minimize material waste. The blank cutting apparatus 200 may comprise one or more cutters, such as plasma cutters (e.g., one or more supports, such as a table, and/or one or more plasma torches moveable by a CNC system, or the like). As such, multiple cutters (e.g., plasma cutters, or the like) may be used in order to form multiple shell blanks 2050 at the same. As such, it should be understood that the plasma cutter may include multiple tables each having a plasma torch, or a single plasma torch may be used on multiple tables. Each table may have capacity to hold one or more material blanks 2020. The plasma cutter operates by passing a gas (e.g., air, inert gas, or the like) through the plasma torch, sparking an electrical arc, and forcing plasma through the tip of the torch to cut the material blanks into shell banks in the desired patterns (e.g., as controlled by the controller 1550). While in some embodiments of the blank cutting apparatus 200, the cutting is performed by plasma cutters, it should be understood that in other embodiments other types of cutters such as laser cutters (e.g., CNC laser cutters, or the like), water cutters (e.g., CNC water-jet cutters, or the like), electrical discharge machines (e.g., CNC electrical discharge machines (EDM), or the like), and/or other like cutters (e.g., shears, stampers, or the like) may be used to form the shell blanks 2050. Regardless of the specific configuration of the blank cutting apparatus 200, it should be understood that the blank cutting apparatus 200 is able to allow for the cutting of one or more material blanks 2020 into one or more shell blanks 2050 at the same time. As such, the blank cutting apparatus 200 is able to receive material blanks 2020, cut the material blanks 2020, and remove the cut shell blanks 2050 through the use of the blank cutting apparatus 200. In one embodiment, the cutting apparatus 200 may receive material blanks 2020 from the material blank rolling table 120, and/or be able to move along and/or over the material blank rolling table 120, for cutting the material blanks 2020 into shell blanks 2050 (e.g., trapezoidal shapes for different sized poles).

As illustrated in FIG. 1, after the material blanks 2020 are cut into the shell blanks 2050, a shell blank handling apparatus may be utilized to transport the shell blanks 2050 from the blank cutting apparatus 200 to downstream apparatuses. In some embodiments, the shell blank handling apparatus may be the same material blank handling apparatus 100 used to transport the material blank 2020 from the material blank supply station 50 to the blank cutting apparatus 200. In other embodiments, the shell blank handling apparatus may be a specific shell blank handling apparatus that is different from the material blank handling apparatus 100. As such, the blank handling apparatus 100 illustrated in FIG. 1 may be made up of a single blank handling apparatus that transports both the material blanks 2020 and the shell blanks 2050, or it may be made up of separate blank handling apparatuses that are specifically used to transport the material blanks 2020 and the shell blanks 2050, respectively. As such, as previously described herein, the shell blank handling apparatus may comprise a crane that lifts the shell blanks 2050 and transports them to a rotation apparatus 300 (e.g., table, stand, or like) and/or a shaping apparatus 400 having one or more shapers (e.g., a presses, benders, stampers, or the like), as will be described in further detail below. The crane may comprise of a gantry crane and vacuum lift that is able to pick and move the shell blanks 2050. While the shell blank handling apparatus may be a crane, alternatively or additionally, it may include conveyors, rollers, drives (e.g., motors, hydraulic, pneumatic, or the like), robots (e.g., robotic arms, moveable robots, or the like) that push, pull, or move the shell blanks 2050. It should be understood that material handling sensors (e.g., lasers, light curtains, cameras, IR sensors, or the like sensors) may be utilized to identify the location of shell blanks 2050 having different attributes (e.g., width, length, thickness, material type, taper, or the like), and a controller 1550 may communicate with the shell blank handling apparatus to pick different shell blanks 2050 based on the sensor information, and the deliver the shell blanks 2050 to the rotation apparatus 300 and/or the shaping apparatus 400. Moreover, after the shell blanks 2050 are removed, the scrap waste from the material blanks 2020 is removed automatically (e.g., rollers, tilting table, a scrap handling robot that picks the scrap from the table, or the like) or manually removed by employees, before another material blank 2050 is delivered to the blank cutting apparatus 200.

In some embodiments the shell blank handling apparatus may pick multiple shell blanks 2050 at the same time. In other embodiments the shell blank handling apparatus may have one or more devices that work in conjunction with each other or separately from each other to pick single shell blanks 2050. Since the shell blanks 2050 may be orientated in opposite directions, in some embodiments, a first shell blank handling apparatus may deliver a first shell blank 2050 that is in the correct orientation directly to the shaping apparatus 400. A such, in some embodiments a second shell blank handing apparatus may be able to rotate the shell blank 2050 before, after or during being transported to the shaping apparatus 400. In some embodiments, the first shell blank apparatus and the second shell blank apparatus that pick the shell blanks 2050 may both be able to rotate shell blanks 2050, only one shell blank apparatus may be able to rotate the shell blanks 2050, or no devices of the shell blank handling apparatus may be able to rotate the shell blanks 2050. As such, when the shell blank handling apparatus does not have the ability to rotate the shell blanks 2050, the shell blank handling apparatus may deliver a first shell (e.g., in the incorrect position) to a rotation apparatus 300, and deliver a second shell (e.g., in the correct position) directly to the shaping apparatus 400.

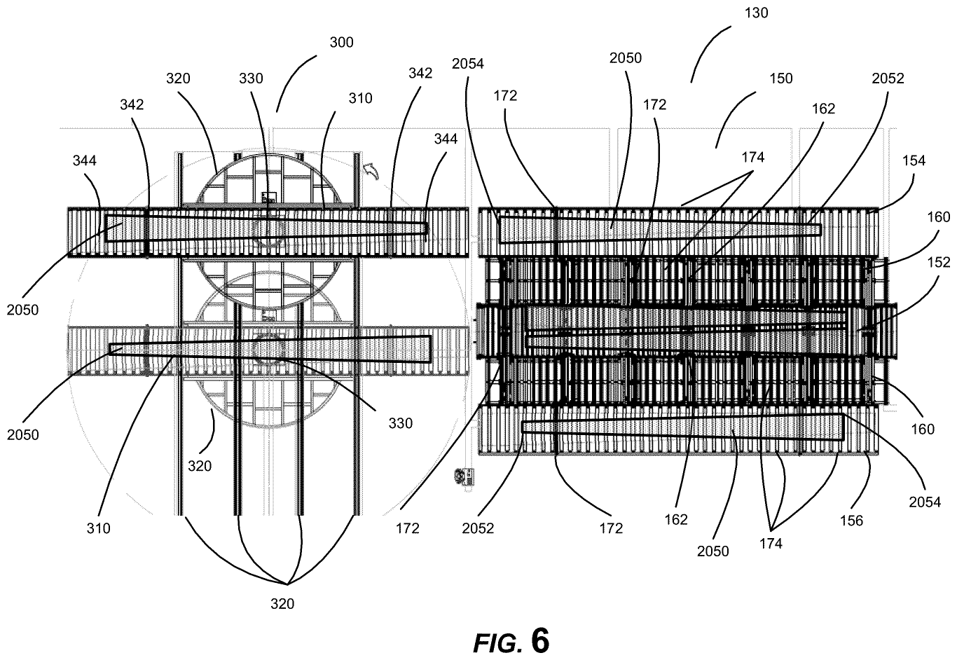

For example, FIG. 6 illustrates one embodiment of a shell blank handling apparatus 130, which may comprise of one or more shell blank tables 150 that receive one or more shell blanks 2050 from the shell blank cutting apparatus 200. As previously discussed, in some embodiments, two or more shell blanks 2050 may be formed from a single material blank 2020, and at least one of the two or more shell blanks 2050 may be located in opposite directions. That is, a first trapezoid shell blank 2050 (illustrated on the bottom of the of the table 150 in FIG. 6) may have a narrower end 2052 on the left, while a second trapezoid shell blank 2050 (illustrated at the top of the table 150 in FIG. 6) may have a narrower end 2052 on the right (e.g., a head-to-toe configuration). As such, after being received from the blank cutting apparatus 200, the shell blank tables 150 illustrated in FIG. 6 may move the shell blanks (e.g., that are in the correct or incorrect orientations) laterally (e.g., horizontally) to different rollers. For example, the shell bank table 150 may have one or more central roller apparatuses 152 that receive the two or more shell blanks. One or more lateral transfer apparatuses 160 may include one or more lateral transfer members 162 (e.g., sloped projections, lateral rollers, moveable arms, or the like) that may extend between adjacent rollers and/or otherwise transfer shell blanks 2050 from the one or more central roller apparatuses 152 laterally to one or more adjacent roller apparatus 154, 156. It should be understood that like the material blank rolling table 120, the shell blank tables 150 and/or the lateral transfer apparatus 160 may include rollers 170, such as driven rollers 172 and/or free rollers 174. The driven rollers 172 may be moved through the use of a drive apparatus comprising one or more drives (e.g., motors, pneumatic, hydraulic, or other like drive), gears, chains, belts, cables, rods, or the like. The free rollers 174 may rotate freely without being driven, as the shell blanks 2050 are moved by the driven rollers 172. The rollers 172, 174 may be single rollers that extend across the individual tables 152, 154, 156 and are parallel with each other, or the rollers may be multiple rollers located in the individual tables that are in series and parallel with each other (e.g., multiple rollers on the same axial, and multiple axils parallel with each other).

It should be understood that the shell bank tables 150 may be used to move the shell blanks 2050 that are in the same or different orientations laterally and/or longitudinally to and/or through the rotation apparatus 300. For example, shell blanks 2050 that are in the correct orientation may be moved past the rotation apparatus 300, outside of or through the rotation apparatus 300 (without rotation, as illustrated in the position of the rotation apparatus 300 on the lower portion of the shell blank handling apparatus 130), while shell blanks 2050 that are in the incorrect orientation may be move laterally and/or longitudinally to the rotation apparatus 300 for rotating the shell blank 2050 to the proper orientation (as illustrated in the position of the rotation apparatus 300 on the upper portion of the shell blank handling apparatus 130, which rotate in order to change the orientation of the shell blank 2050).

The rotation apparatus 300 may comprise one or more rotator tables 310 that may move in various orientations, such as in a horizontal orientation, vertical, or angled orientation, as well as rotate, to position the shell blank 2050 into the correct orientation (e.g., rotates 180 degrees, or the like) before the shell blank 2050 is transported to the shaping apparatus 400. For example, as illustrated in FIG. 6, one or more rotator tables 310 (illustrated as one rotator table in two different positions) may move laterally, vertically, and/or may rotate. For example, the one or more rotator tables 310 may move laterally through the use of one or more tracks 320 and/or one or more carriages 330. Additionally, or alternatively, the one or more rotator tables 310 may also rotate around a vertical axis 330 (e.g., central axis or another axis). Additionally, or alternatively, in some embodiments, the one or more carriages 330 may have a lift that allows the one or more rotation tables 310 to move vertically (e.g., upwards or downwards, out of the page illustrated in FIG. 6) such that one rotator tables 310 may be rotated over other apparatus (e.g., another rotation table 310, a static table, or the like), in order to rotate a shell blank 2050 while other shell blanks 2050 are being moved longitudinally downstream and/or in order to receive a shell blank 2050 from different vertical positions of a shell blank holding apparatus 610, as will be described in further detail herein below. As such, the one or more rotator tables 310 may be moved manually, move using one or more rotator drive apparatuses having one or more rotator drives (e.g., electric motors, through pneumatics, through hydraulics, or other source of power) supports, gears, wheels, chains, cables, bands, belts, rods, or the like. As such, the one or more rotator drive apparatuses may be a single drive or may be multiple drives that move one or more carriages laterally, allows the rotation table 310 directly (or through the use of the carriage 330) to rotate (e.g., using a support, such as a central support), and/or allows the table directly (or through the use of the carriage 330 and/or lift thereof) to move vertically (up and down).

It should be understood that like the material blank rolling table 120 and the shell blank tables 150, the one or more rotation tables 310 may include rollers 340, such as driven rollers 342 and/or free rollers 344. The driven rollers 342 may be moved through the use of a drive assembly having a drive (e.g., motor, pneumatic, hydraulic, or the like drive) gears, chains, belts, cables, or the like. The free rollers 344 may rotate freely without being driven, as the shell blanks 2050 are moved by the driven rollers 342. The rollers may be single rollers that extend across the table and are parallel with each other, or the rollers may be multiple rollers that are located in series and parallel with each other (e.g., multiple rollers on the same axial, and multiple axils parallel with each other).

As such, the rotation apparatus 300, and in particular embodiments, the one or more rotation tables 310, may move laterally, vertically, and/or may rotate to move to different positions with respect to the shell blank tables 150 in order to receive shell blanks 2050 from the shell blank tables 150 in different lateral positions, potentially rotate to change the orientation of the shell blanks 2050, and transport the shell blanks downstream (e.g., using rollers, or the like) for further processing. For example, the rotation apparatus 300 may move vertically in order to locate the shell blanks in different vertical positions for delivery to the holding station 600 (e.g., shell blank holding apparatus 610), as described in further detail below.

In some embodiments, a shell blank handling apparatus 130 and/or the rotation apparatus 300 may deliver the shell blanks 2050 directly to the shaping apparatus 400, however, in some embodiments, the shell blanks 2050 may be delivered to a holding station 600, which will be described in further detail below. In some embodiments, after the blank handling apparatus 100 (e.g., shell blank handling apparatus 130) and/or the rotation apparatus 300 delivers the shell blanks 2050 to the shaping apparatus 400 and/or the holding station 600, the blank handling apparatus 100 (or portions thereof) returns to transport (e.g., pick, move, or the like) material blanks 2020 for cutting and/or to transport (e.g., picks, move, or the like) shell blanks 2050 for rotation and/or for transport to the shaping apparatus 400 and/or holding station 600.

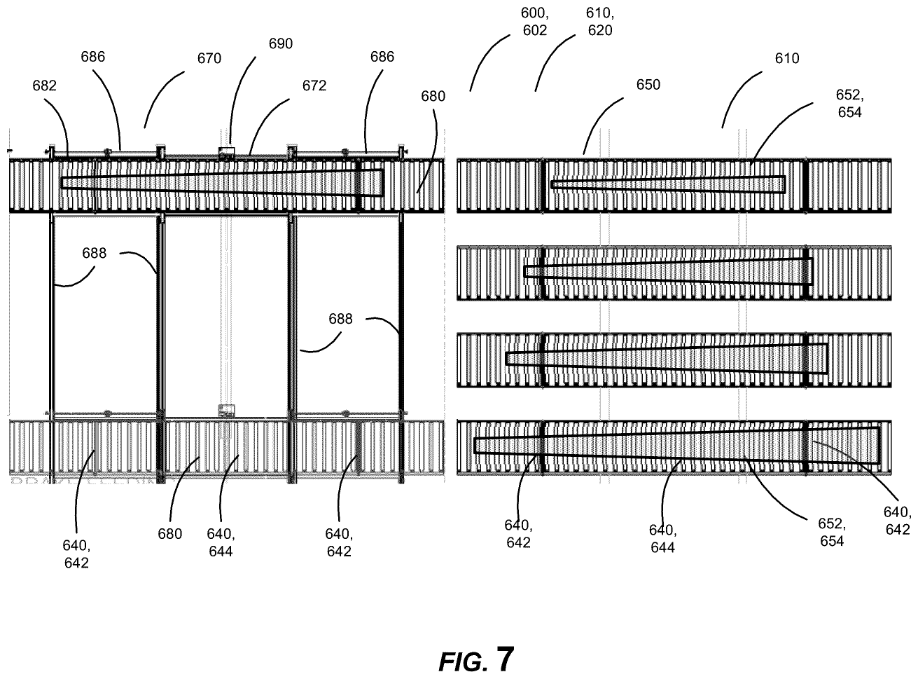

The holding station 600 (e.g., storage area for shell blanks 2050, and/or shaped shells 2100 if multiple holding stations 600 are utilized) may be used to hold shell blanks 2050 before shaping and/or shaped shells 2100 after shaping. As such, the holding station 600 may have a holding apparats 602 comprising a shell blank holding apparatus 610 and/or a shaped shell holding apparatus 620. Regardless of the type of holding apparatus 602, the holding apparatus 602, as illustrated in FIG. 7, may include a rack apparatus 650 (e.g., with or without rollers) spaced vertically and/or laterally that may hold one or more shells (e.g., multiple shells of different sizes, such as lengths, widths, or the like, as single shell blanks or stacked shell blanks), which may be flat shell blanks 2050 before shaping or shaped shells 2100 depending on the type of holding station 600. The plurality of racks 652 may be placed laterally (e.g., two or more lateral racks 654) and/or vertically on top of each other and/or offset from each other (e.g., not visible in the top view of FIG. 7). As such, different shells (e.g., flat shell blank 2050, shaped shells 2100, or the like depending on the rack) having different attributes (e.g., sizes, such a lengths, widths, material type, or the like) are stored on different racks 652. As described herein, when a particular pole 2200 is being manufactured, the required shell blank 2050 for shaping, and/or an already shaped shells 2100 (e.g., half, tri-shell, quad-shell, or the like), having specific attributes (e.g., having a particular length, diameter, width, material, or the like) may be transported (e.g., picked, moved, or the like) from the holding apparatus 602 and delivered for downstream processing.

A handling apparatus (e.g., the same as or different than as previously described herein with respect the blank handling apparatus 100) may be used to transport the shell blanks 2050 from the holding station 600 to the shaping apparatus 400. However, in some embodiments, the handling apparatus may be the feeder apparatus 670 illustrated in FIG. 7. It should be understood that the handling apparatus may be a single feeder apparatus 670 (illustrated in two different positions in FIG. 7) or it may be multiple feeder apparatus 670 that work individually, or jointly, with respect to each other. As illustrated in FIG. 7, the feeder apparatus 670 may comprise an adjustable feeder apparatus 672 comprising a feeder table 680 with feeder rollers 682 (e.g., driven and/or free rollers, the same as or similar to the rollers previously described herein), a feeder carriage 686 supporting the feeder table, and feeder tracks 688 that allow the feeder carriage 686 to move laterally along the tracks. In some embodiments, the feeder carriage 686 may include a lift that also allows the carriage 686 to move vertically. The carriage 686 and/or the lift may be moveable manually or automatically using one or more feeder drive apparatuses 690 having a drive (e.g., motor—electrically powered, pneumatically, hydraulically, or the like). The one or more feeder drive apparatuses 690 may further comprise moveable supports, gears, wheels, chains, cables, bands, belts, rods, or the like that are used to allow for movement of the feeder table 680 (e.g., through the carriage 686, lift, or the like). The one or more drive apparatuses 690 allows for the positioning of the feeder table 680 at the desired location (e.g., laterally illustrated in FIG. 7, and vertically, which is not illustrated in FIG. 7) with respect to one of the plurality of racks 652 previously described herein. As such, the feeder apparatus 670, and in particular, the feeder table 680 may be moved with respect to the rack apparatus 650 and/or the shaping station 400, in order to transport a particular shell blank 2050 that is received from the rack apparatus 650 and deliver the shell blank 2050 to the shaping station 400.

It should be understood that like the material blank rolling table 120, the shell blank tables 150, and/or the one or more rotation tables 310, the rack apparatus 650 and/or the feeder apparatus 670 may include rollers 640, such as driven rollers 642 and/or free rollers 644. The driven rollers 642 may be moved through the use of a drive apparatus having drives (e.g., motor, pneumatic, hydraulic, or the like drive), gears, chains, belts, cables, rods, or the like. The free rollers 644 may rotate freely without being driven, as the shell blanks 2050 are transported by the driven rollers 642. As such, the shell blanks 2050 may be transported (e.g., picked, moved, or the like) from the rack apparatus 650 to the feeder apparatus 670 and then to the shaping apparatus 400 through the use of the rollers 640. The rollers may be single rollers that extend across the table and are parallel with each other, or the rollers may be multiple rollers that are located in series and parallel with each other (e.g., multiple rollers on the same axial, and multiple axils parallel with each other).

The shaping apparatus 400 is configured to shape the one or more shell blanks 2050 individually or at the same time into shaped shells 2100 (e.g., single shells, half-shells, tri-shells, quad shells, or the like). In some embodiments, the shaping apparatus 400 may comprise of one or more presses that bend the shell blanks 2050 as the shell blank 2050 is moved to different positions in order to form the shaped shell 2100. In some embodiment, shaping apparatus 400 may be an actuating press; however, additionally or alternatively, shaping apparatus 400 may utilize rollers, arms, bending members, stamping, or the like devices to form the shaped shells. It should be understood that there may be multiple shaping apparatuses 400 or a single shaping apparatus 400, each of which may include a single shaper (e.g., press, rollers, arms, bending members, stamping members, or the like) or may include multiple shapers (e.g., multiple presses, or the like). As such, the shapers 402, such as multiple shapers may be located in-line longitudinally with respect to each other, and/or spaced laterally with respect to each other. In some embodiments, a single shaper may be used to form a shaped shell 2100, or multiple shapers may be used to create a shaped shell 2100 (e.g., depending on the size of the shell blank 2050). As such, the shapers 402 may work jointly in conjunction with each other and/or may move independently of each other. Moreover, it should be understood that a shaping apparatus 400 may be able to handle any shell blank 2050 and bend it into any type of shaped shell 2100; however, in other embodiments the shaping apparatus 400 (e.g., with one or more shapers 402) may be pre-configured to shape one or more different types of shell blanks 2050 into one or more shaped shells 2100.

As such, in some embodiments the controller 1550 may maneuver a blank handling apparatus (e.g., a shell handling apparatus 130, or the like) to automatically send specific shell blanks 2050 to a specific shaping apparatus 400 based on what shaping apparatus 400 is open, based on what shaping apparatus 400 can handle a specific shell blank 2050 to form a specific shaped shell 2100 (e.g., if the shaping apparatus 400 is set up to form specific shells 2100), based on the availability of other downstream processing, based on the timing of orders that have been made and need to be completed, or the like. Moreover, in some embodiments the controller 1550 may maneuver a blank handling apparatus to automatically send specific shell blank 2050 to a specific location within the shaping apparatus 400 to position the shell blank 2050 in the correct position with respect to one or more shapers 402 (e.g., specific presses, or the like) in order to form a specific shaped shell 2100. The controller 1550 may further control the shaping apparatus 400 (e.g., where to bend, or the like) in order to form the specific shaped shell 2100 needed. Once the shaping apparatus 400 shapes the shells 2100, the shaped shells 2100 are transported from the shaping apparatus 400 for further processing.

It should be understood that in some embodiments of the invention, one or more sensors may be used to locate the shell blank 2050 within the correct position of the shaping apparatus 400 (e.g., locate one or more ends of the shell blank 2050 with respect to the one or more shapers 402). Furthermore, a shell blank 2050 may have one or more markings (e.g., permanent or semi-permanent markings, such as etchings, ink, paint, coating, adhesive, tapes, or the like, or non-permanent markings, lasers, lights, or the like) that indicate where the shell blank 2050 should be bent. Consequently, the one or more sensors and/or controller 1550 may verify the markings on the shell blank 2050 and/or shaped shell 2100 (e.g., partially shaped shell) and/or the location of the shell blank 2050 and/or shaped shell 2050 with respect to the one or more shapers 402, in order to properly shape the shell blank 2050 into the shaped shell 2100. It should be understood that the sensors may be any type of sensor, such as but not limited to tags (e.g., NFC, RFID, or the like), lasers, light curtains, reflective surface sensors, cameras, color sensors, or the like type of sensor may be used to determine the position of the shell blank 2050 or the shaped shell 2100, and/or markings thereof, before shaping, during, and/or after shaping.

As described above, the one or more sensors may be used to make sure the shell blank 2050 is in the correct position before and/or during shaping. It should be understood that the blank handling apparatus (e.g., a shell blank handling apparatus, or other material handling apparatus) may be used to position the shell blank 2050 within the shaping apparatus 400. Additionally, or alternatively, the shaping apparatus 400 may have its own shell blank handling apparatus, such as a rolling table, moveable end and/or intermediate supports, conveyors, moveable robotic arms, or the like that may be used alone, or in combination with the one or more sensors, to position the shell blank 2050 before or during the shaping of the shell blank 2050. As such, the shell blank 2050 may be positioned and moved during shaping in various ways, including the ways any type of material described herein is moved.

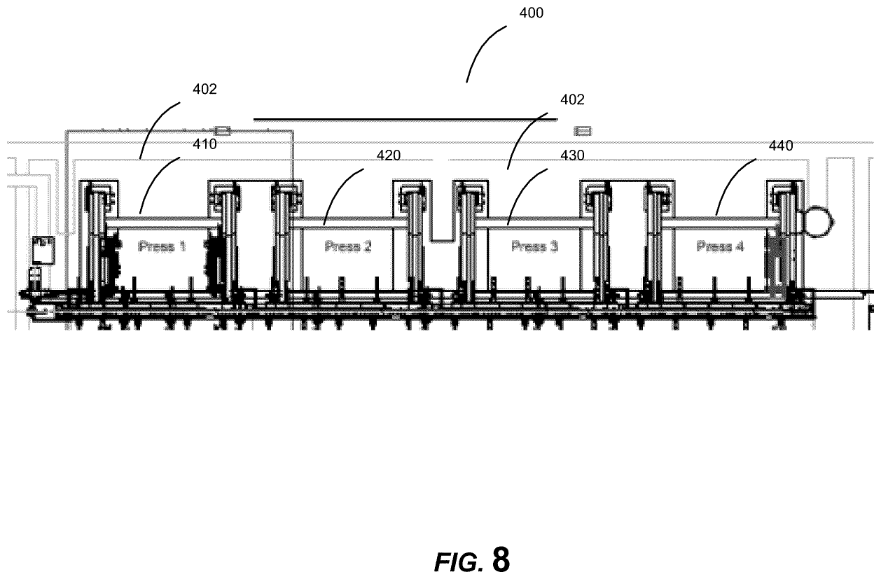

One embodiment of the shaping apparatus 400 is illustrated in FIG. 8, in which one or more shell blanks 2050 may be shaped into the shaped shell 2100 based on production requirements (e.g., full shells, half-shells, tri-shells, quarter shells, or the like). For example, different shapers 402 (e.g., presses, or the like, such a first press 410, a second press 420, a third press 430, a fourth press 440, or the like) may work independently, or in conjunction with, each other (e.g., depending on the size of the shell blank 2050) to form the shaped shell 2100. For example, a first shaper 410 and a second shaper 420 may be used to form a smaller shaped shell 2100, while all four shapers 410, 420, 430, 440 may be used to form a larger shaped shell 2100. In some embodiments, the one or more shapers 402 may form multiple bends in the shell blank 2050 at the same time or may form a single bend in the shell blank 2050 at a time. For example, in some embodiments the shaping process may press a quarter shell by making multiple bends. Additionally, or alternatively, the shaping process may include pressing a first portion of the shell blank 2050, moving the shell blank to a different position (e.g., sliding, rotating, or the like) an pressing a second portion of the shell blank 2050, and the process is repeated until the shaped shell 2100 is completed. After the shaped shell is formed, it may be transported downstream for further processing through a specialized handling apparatus and/or one of the handling apparatuses described herein.

As illustrated in FIG. 1, a shell assembly apparatus 30 may be utilized to form the shaped shells 2100 into pole 2200. As such, after the shaped shells 2100 are formed, the shaped shells 2100 may be moved downstream to a shaped shell holding apparatus 620 (as previously discussed herein with respect to the shell blank holding apparatus 610) and/or to a seam assembly apparatus 700 (as will be described in further detail herein). As illustrated in block 500 of FIG. 1, a shell handling apparatus 500 may be used to transport the shells from the shaping apparatus 400 to the shaped shell holding apparatus 620 and/or to the seam assembly apparatus 700 (e.g., based on if the shaped shell 2100 is ready for assembly and/or the seam assembly apparatus 700 is open). In some embodiments, the seam assembly apparatus 700 comprises one or more seam welding apparatuses 702. As such, in some embodiments a shaped shell 2100 is a single shaped shell 2110 so it may be ready to receive the seam weld; however, in some embodiments the shell is a partial shell 2120, which requires one or more additional partial shells 2120 (e.g., two or more shaped shells 2100) before a seam can be welded. As noted, the seam assembly apparatus 700 may have one or more seam welding apparatuses 702 (e.g., a single seam welder apparatus 710, a multiple seam welder apparatus 720, or the like) that can be used to create a single weld on one or more shaped shells 2100 at a time, create multiple welds on one or more shaped shells 2100 at a time (e.g., welds at least two seams on at least two shells at the same time in the same station), and/or creates single or multiple welds at different stations on different shaped shells 2100 at the same time. The one or more seam welding apparatuses 702 may have movable welding robots that move along the length of one or more shaped shells 2100 in order to form the seam welds (e.g., longitudinal seam welds). In other embodiments, the one or more shaped shells 2100 may move with respect to a stationary and/or moveable welding robot in order to form the seam welds. In some embodiments, the seam welders of the seam welding apparatus 702 may create a single weld in a single shaped shell 2110 to form a seamed shell 2150. In other embodiments, the seam welders of the seam welding apparatus 702 may create two seams between two half shells, three seams between three tri-shells, four seams between four quarter shells, or the like. It should be understood that the seam welders may be able to weld any type of shaped shell 2100 or combination of shaped shells 2100, or one or more of the seam welders may be set up to weld specific types of shaped shells 2100 and/or combinations of shaped shells 2100 (e.g., sizes, number of shells, or the like). As such, the controller 1550 will direct the shell handling apparatus 500 to provide one or more shaped shells 2100 to one or more weld seam welding apparatuses 702 within the seam assembly apparatus 700 in order to optimize the seam welding of the shaped shells 2100 based on orders, shaped shells 2100 in stock, shaped shells being formed, poles 2200 in process downstream of the seam assembly apparatus 700, or the like. In some embodiments, when the seam assembly apparatus 700 is at capacity, the shell handling apparatus 500 may hold the shaped shell 2100 until a seam welding apparatus 702 has capacity, alternatively, the shell handling apparatus 500 may store the shell in a shaped shell holding apparatus 620 (e.g., as previously described herein with respect to the shell blank holding apparatus 610) until the seam assembly apparatus 700 has capacity. It should be understood that the shaped shell holding apparatus 620 may be the same as, or similar to, the shell blank holding apparatus 610 previously discussed herein.

It should be understood that the seam assembly apparatus 700 is generally described herein as having one or more seam welding apparatuses 702, in which the seam of one or more shape shells 2100 is formed by welding the seam of a single shaped shell 2110, or two or more seams of two or more mating shaped shells 2120. It should be understood that in other embodiments, the seams of one or more shaped shells 2100 may be formed (and thus the shells may be formed into seamed shells 2150) through the use of other couplings. For example, the shaped shells have may flanges, edges that overlap, or the like that may be operatively coupled through the use of fasteners (e.g., bolts, nuts, rivets, or other like fasteners), or other types of connections other than welds or fasteners.

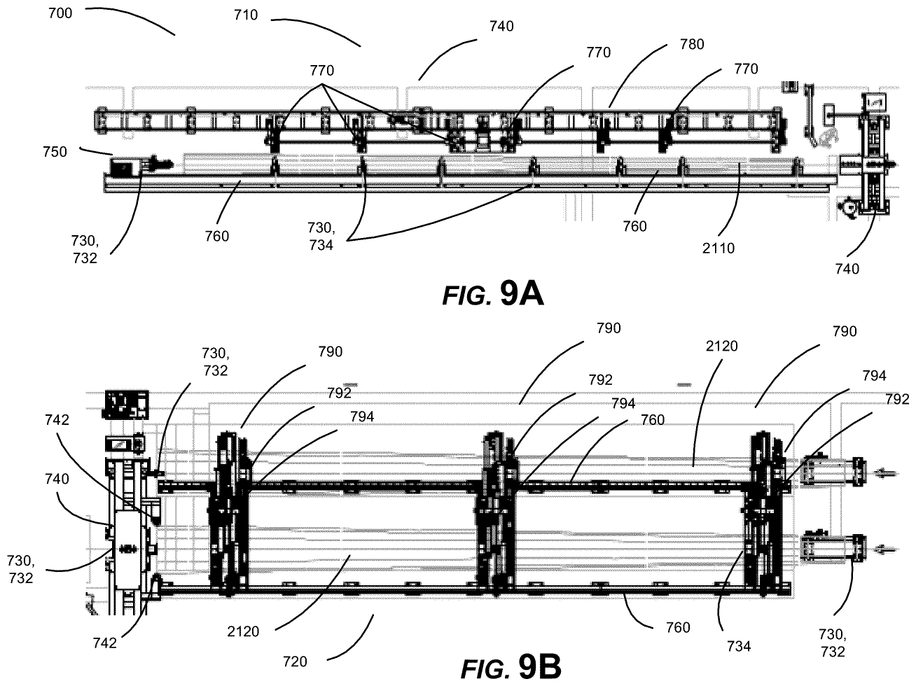

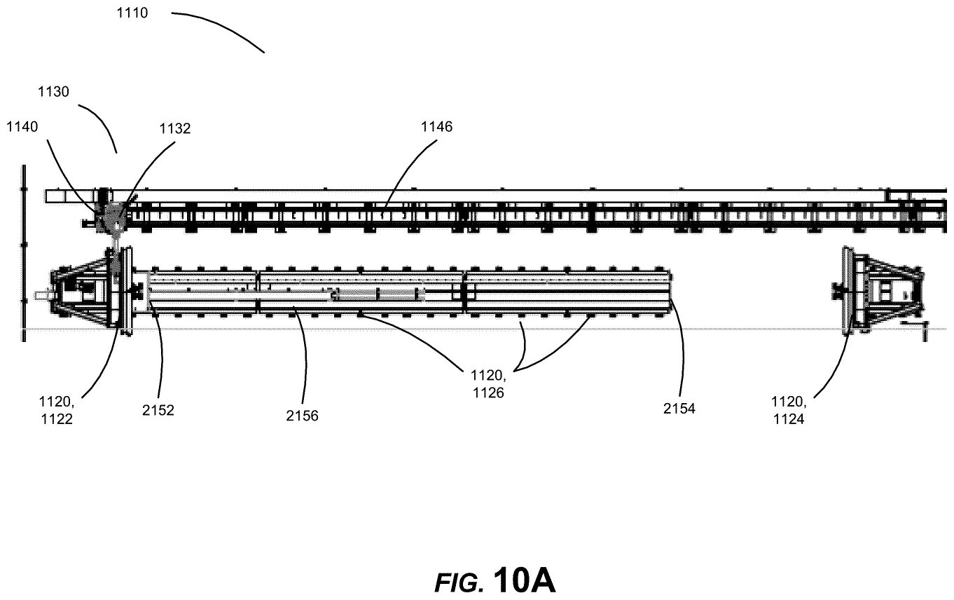

FIGS. 9A and 9B, illustrate embodiments of seam welding apparatuses 702 within the seam assembly apparatuses 700, such as a single seam welding apparatus 710, as illustrated in FIG. 9A, and a multiple seam welding apparatus 720, as illustrated in FIG. 9B. As illustrated in FIG. 9A, the single shell 2110 may be received from the shaping apparatus 400 and/or the shaped shell holding apparatus 620. Alternatively, or additionally, as illustrated in FIG. 9B, the two or more shaped shells 2120 may be provided to the multiple seam welding apparatus 720 as separate shells (e.g., with the shell openings facing up, and the outer shell surfaces being supported, or the like). In other embodiments, the partial shaped shells 2120 may be at least partially pre-assembled (e.g., two half-shells, three-tri-shells, four quad-shell are located in the correct position) before moving to the multiple seam welding apparatus 720) for seam welding. As illustrated in FIGS. 9A and 9B, the single seam welding apparatus 710 and/or the multiple seam welding apparatus 720 may use one or more shell seaming supports 730, such as end shell seaming supports 732 and/or intermediate shell seaming support 734. The shell seaming supports 730 may comprise clamps, brackets, fasteners, rollers, grippers, or the like that are used to hold the one or more shaped shells 2100 in place during the seam welding process.

In some embodiments, as illustrated in FIGS. 9A, a single shaped shell 2110 may by operatively coupled to an end shell seaming support 732 upstream of the automated welding apparatus 740 (not shown) and pulled through the automated welding apparatus 740 (otherwise described as a robotic welding apparatus), as the seam is being welding, and the intermediate shell seaming supports 734 engage the single shaped shell 2110 as it is being welded and pass each intermediate shell seaming support 734 (as illustrated in FIG. 9A after the seam weld has been completed and the seamed shell 2100 is pulled through the automated welding apparatus 740). For example, the end shell seaming support 732 may be operatively coupled to a seam welding support carriage 750, which is moveable with respect to one or more seam welding tracks 760. The seam welding support carriage 750 may be moveable through the use of a seam support drive assembly having a drive (e.g., motor, pneumatic, hydraulic, or other like drive), gears, wheels, belts, cables, chains, or the like. As such, as the seam welding support carriage 750 of the end shell seaming support 732 travels along the one or more seam welding tracks 760, the automated welding apparatus 740, in particular, a seam welding robot 742 may weld the seam of the single shell 2110. It should be understood that in some embodiments the seam welding robot 742 may be moveable in multiple degrees of freedom to allow for welding of the seam of a single shell 2110 have different sizes, lengths, width, or the like, and/or to account for the taper in the shape of the single shell 2110. As further illustrated in FIG. 9A, as the end shell seaming support 732 moves with the carriage 750 along the tracks 760, one or more of the intermediate shell seaming supports 734 are positioned to engage and support the seamed shell 2150. For example, the intermediate shell seaming supports 734 may be rollers are able to move vertically, laterally, rotationally, or the like to be moved into place to support the seamed shell 2150 as the tapered seamed shell 2150 is pulled along through the automated welding apparatus 740 by the end shell seaming support 732. Since the seamed shell 2150 is tapered, the intermediate shell seaming supports may adjust as the seamed shell 2150 is moved over each intermediate shell seaming support and the diameter of the seamed shell 2150 changes. In alternate embodiments the single shaped shell 2110 may be stationary while the automated welding apparatus 740, and in particular, the seam welding robot 742 moves along the stationary single shaped shell 2110 (e.g., through the carriage 750 and/or tracks 760) to weld the seam to form the single shaped shell 2110. Regardless of the configuration of the single seam welding apparatus 710, after the seam is formed to create the welded seam within the single shaped shell 2110 to form the seamed shell 2150, the seamed shell 2150 is transported using a material handling apparatus, such as through the use of a crane, lateral rollers, or moveable arms that transfer the seamed shell 2150 for downstream processing (e.g., using a drive apparatus, or the like). For example, the transfer arms 770 may extend under the seamed shell 2150 and transport the seamed shell 2150 to a seamed shell table 780 by lifting, pulling, rotating, and/or lowering the seamed shell 2150 onto the seamed shell table 780. The seamed shell table 780 may transport the seamed shell 2150 downstream for further processing, such as through the use of rollers (e.g., driving and/or non-driven rollers, as previously discussed herein). Thereafter, the carriage 750 with the end shell seaming support 732 may return adjacent to the automated welding apparatus 740 to be operatively coupled to the next single shell 2110 for additional seam welding.

Additionally, or alternatively, FIG. 9B illustrates a multiple seam welding apparatus 720 that may be able to weld a seam of a single shell 2110 or multiple seams of two or more shells 2120 to form a seamed shell 2150. In some embodiments the multiple seam welding apparatus 720 may also comprise an automated welding apparatus 740 (otherwise described as a robotic welding apparatus) having one or more seam welding robots 742 with multiple degrees of freedom for welding the seams. In some embodiments, the shell seaming support 730 may comprise a shell mating apparatus 790. As illustrated in FIG. 9B, two half shells 2120 may be positioned adjacent to each other in the multiple seam welding apparatus 720 (e.g., with the open end of the u-shaped shell facing up). The shell mating apparatus 790 may have one or more mating drive apparatuses 792 having one or more mating drives (e.g., motors, pneumatic, hydraulic, or the like), mating support members 794 (e.g., arms, or the like), gears, chains, belts, cables, rods, or the like. As such, the one or more mating support members 794 are able to transport (e.g., lift, rotate, and drop, or the like) one partial shell 2120 onto another partial shell 2120 (e.g., position one shell on top of another, or the like) to create an unseamed assembled shell. The shell mating apparatus 790 may hold the shell in place until the seam(s) are welded. In some embodiments, the shell mating apparatus 790 (e.g., the mating support members 794, or the like) may be moved to different longitudinal positions, such as through a support carriage 750 and/or one or more tracks 760, as previously discuss herein, such as to accommodate shaped shells 2100 of different sizes. After the two or more shaped shells 2120 are mated with each other into an unseamed assembled shell, the unseamed shell may be transported through the welding apparatus 740 (e.g., pushed by the shell seaming support 730, such as the shell assembly apparatus 790, or other like supports, pulled by an end shell seaming support 732, as previously described herein, or the like). Regardless of how the unseamed assembled shell is transported through the automated welding apparatus 740, in some embodiments multiple seam welding robots 742 may be used to weld two or more seams of the unseamed shell together. Moreover, as previously discussed with respect to the single seam welding apparatus 710, in some embodiments the automated welding apparatus 740 of the multiple seam welding apparatus 720 may move while the unseamed shell remains static.

The seam welding robots 742 described with respect to FIGS. 9A and 9B may be the same as, or similar to, the welding robots 1700 that will be described in further detail herein with respect to the pole component welding robots. As such, the seam welding robots 742 may have one or more articulating arms, one or more moveable effector ends, and/or one or more welding tips). The welding robots 742 may welds the seam continuously in one or more passes, and/or multiple welding robots 742 may weld a portion of the seam in a single pass. Alternatively, or additionally, multiple robotic welding robots 742 may weld different seams of multiple shaped shells 2100 at the same time. After seaming, the one or more seamed shells 2150 may be sent for downstream processing and/or may be held in a holding station 600 until downstream processing is available.

In some embodiments, once the seam welds are formed in the shells 2100 to create the seamed shells 2150, a pole handling apparatus 800 may be used to transport the poles to one or more cells for additional processing. In some embodiments, the pole handling apparatus 800 may comprise a conveyor system that is used to transport the seamed shells 2150 for further processing. However, in some embodiments, additionally and/or alternatively, the pole handling apparatus 800 can transport the seamed shells 2150 using rollers, a crane, a vehicle, or the like, as discussed herein. The controller 1550 may direct the pole handling apparatus 800 to deliver the seamed shells 2150 to one or more cells for further processing based on cell availability, sensors or manual input based on issues identified with the seamed shells 2150 (e.g., defects, or the like), the configuration for the seamed shells 2150 based on orders, or the like. The cells that may be used for additional processing may comprise a straightening cell 900, a trim cell 1000, a component assembly cell 1100, a slip-joint cell 1200, an inspection cell 1300, and/or coating, shot-blasting, and/or packing cells 1400, as will be described in further detail below. It should be understood that the functions performed within these cells may be performed in a single cell or different cells using a single apparatus and/or multiple apparatuses.

After seam welding to form the seamed shell 2150, the pole handling apparatus 800 may transport the seamed shell 2150 to a straightening cell 900. Not all seamed shells 2150 will require straightening, and as such, sensors (e.g., in the seam assembly apparatus 700, pole handling apparatus 800, or the like), and/or manual inspection may determine if a seamed shell 2150 requires straightening. In some embodiments, the pole handling apparatus 800 may comprise a straightening member (e.g., a hydraulic straightening beam, or the like) that removes bowing in the pole. The process may include straightening the pole without heating the pole, which could increase production time. In other embodiments, the pole may be straightened using other equipment in heated or non-heated processes. It should be understood that in some embodiments the straightening may occur in a straightening cell; however, in some embodiments the straightening may be performed within the seam assembly apparatus 700 (e.g., before, during, or after the longitudinal seam is formed).

After seam welding and/or after straightening, the pole handling apparatus 800 may transport the pole to a trim cell 1000 configured to cut the pole to the required length and diameter (e.g., by trimming one end verses the other end to define the diameter on either end of the pole), form apertures in the pole for attaching components, and/or scribe markings on the pole for layouts, to aid in installation, to provide instructions, for forming branding or logos, or the like. It should be understood that in some embodiments the trimming may occur in a trim-cell 1000; however, in other embodiments the trimming may be performed within the seam assembly apparatus 700 (e.g., before, during, or after the longitudinal seam is formed) and/or within a combined straightening and trimming cell.

After seam welding, straightening, and/or trimming, the seamed shell 2150, the pole handling apparatus 800 may transport the seamed shell 2150 to a fit-up cell and/or a component assembly cell 1100, which may be different cells or a combined in single cell. Within these one or more cells, the pole components 2160 (e.g., hardware—clips, support members for vangs or the like, flanges—base flange 2172, intermediate flange 2174, top flange 2176, or the like) may be automatically positioned, tack welded, and/or welded to the seamed shell 2150. Additionally, or alternatively, the one or more components 2160 may be operatively coupled to the seamed pole 2150 in other ways (e.g., other couplings, such as fasteners, such as bolts, nuts, studs, rivets, or the like). In some embodiments, the component assembly cell 1100 may comprise one or more cutting cells and/or one or more welding cells that may be used to create apertures in the seamed shell 2150 for attachment of components 2160. As such, the component assembly cell 1100 may have one or more robotic apparatuses that used robotic cutters and/or welders to attach pole components 2160 and form welds between the components 2160 and the seamed shell 2150. The component assembly cell 1100 may further comprise component handling apparatuses (e.g., robots, lifts, or the like) that pick, place, and/or hold the components in the correct positions for welding the components 2160 to the seamed pole 2150. In some embodiments, the components 2160 may be pre-heated to improve the speed of the welding process. The one or more robotic cutters, welders, and/or component handling apparatuses within the component assembly cell 1100 may be movable (e.g., moveable robots) that move along the length of one or more poles in order to create the apertures, form the welds, and/or assemble the components in other ways. In other embodiments the one or more seamed shells 2150 may be move (e.g., rotating, longitudinally, or the like) with respect to a stationary and/or moveable robotic apparatuses in order to aid in the assembly of the components to the seamed poles 2150. It should be understood that in some embodiments the fit-up and/or welding of the components 2160 may occur in the component assembly cell 1100; however, in some embodiments the fit-up and/or welding may be performed within the seam assembly apparatus 700 (e.g., before, during, or after the longitudinal seam is formed), within a straightening cell 900, and/or within a trimming cell 1000.

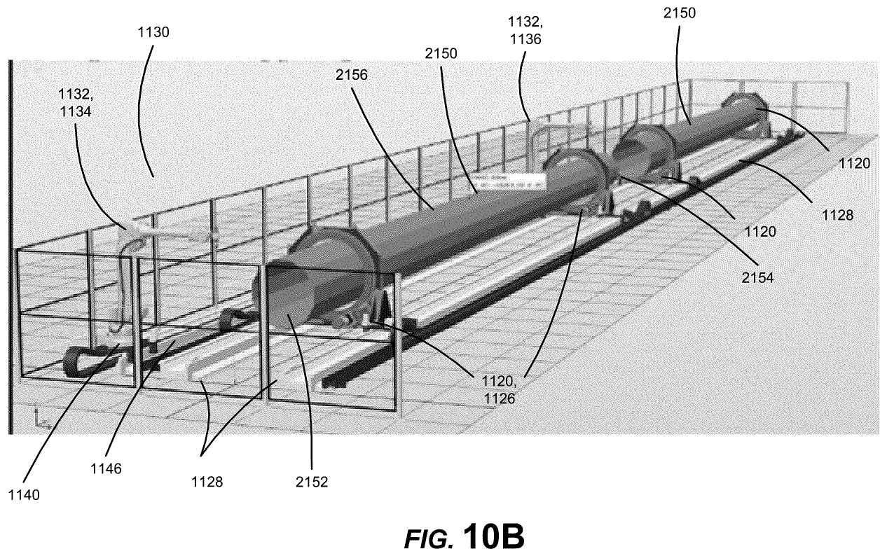

As illustrated in FIGS. 10A and 10B, in some embodiments, the one or more component assembly cells 1100 may comprise one or more seam cutting apparatuses 1110 (otherwise described as a seemed shell cutting apparatus), which may be used to prepare the seamed shells 2150 for the welding of the pole components 2160. The pole handling apparatus 800 (e.g., an overhead crane, a forklift, rolling table, or the like) may be used transport the seamed shells 2150 to the cutting apparatus 1110. In some embodiments, the cutting apparatus 1110 is a plasma cutting apparatus 1110. Within the plasma cutting apparatus 1110, the seamed shells 2150 are supported by one or more cutting supports 1120 (e.g., plasma cutting supports). The plasma cutting supports 1120 may be any type of supports, but in some embodiments may be headstock supports 1122, tailstock supports 1124, and/or intermediate supports 1126 (e.g., clamping support, or the like). For example, the headstock supports 1122 and tailstock supports 1124 may be used to support the ends of the seamed shell 2150 (e.g., through the opening at the ends 2152, 2154 of the seamed shell 2150). Additionally, or alternatively, the intermediate supports 1126 may utilize clamping chucks (e.g., hydraulic clamping chucks, or the like) to clamp the seamed tube in place at the ends 2152, 2154 of the seamed pole 2150, adjacent the ends 2152, 2154 of the seamed shell 2150, and/or at one or more locations with the body 2156 of the seamed shell 2150. In some embodiments, the plasma cutting supports 1120 may be independently moveable, or may be moveable through the use of one or more cutting support tracks 1128, such as through the use of wheels, drives (e.g., motors, hydraulic, or pneumatic driven devices), gears, belts, cables, chains, or the like. The plasma cutting supports 1120 may be used to center the tapered seamed shell 2150 along the centerline and zero in the position of the seamed shell 2150 for plasma cutting.

The plasma cutting apparatus 1110 (e.g., otherwise described as a cutting apparatus 1110 that uses any type of cutter) may further comprise a robotic plasma cutting apparatus 1130 (otherwise described as a robotic cutting apparatus 1130, or automated cutting apparatus) having one or more plasma cutting robots 1132 (e.g., a first cutting robot 1134 and a second robot 1136), one or more plasma cutting robot carriages 1140 and one or more plasma cutting robot tracks 1146. Each of the plasma cutting robots 1132 may be operatively coupled to a carriage 1140 and may move independently along the one or more tracks 1146. As described herein with respect to other carriages and/or tracks, the one or more plasma cutting robot carriages 1140 may be moveable manually, using a drive assembly having a drive (e.g., a motor, pneumatic, hydraulic, or the like drive). The drive assembly may further comprise moveable supports, gears, chains, cables, bands, belts, or the like that are used to allow for movement of the plasma cutting robot carriage 1140 along the plasma robot tracks 1146. As such, the one or more plasma cutting robots 1132 may be moved adjacent the ends 2152, 2154 of the seamed shell 2150 and used to prepare the ends of the seamed shells 2150 for connections of flanges 2170 (otherwise described as plates, such as a base flange, intermediate flange, top flange, or the like), such as by chamfering the ends 2152, 2154 of the seamed shell 2150 to prepare the ends 2152, 2154 of the seamed shell 2150 for welding with the flanges 2170.

The same or different plasma cutting robots 1132 may be moved with respect to the seamed shell 2150 and/or the plasma cutting supports 1120 may rotate the seamed shell 2150 in order to form apertures 2180 (e.g., holes, slots, or the like) of different sizes and/or shape in order to allow for downstream processing for connecting the pole components 2160 to the seamed shell 2150. After the ends 2152, 2154 of the seamed shell 2150 are prepared (e.g., chamfered, or the like) and/or the apertures 2180 are formed in the seamed shells 2150, the pole handling apparatus 800 (e.g., an overhead crane, a forklift, rollers, the supports 1120—may be moveable, or the like) may be used transport the seamed pole 2150 for additional processing. It should be understood that the plasma cutting supports 1120 and/or the robotic cutting apparatus 1130 may be used on a single seamed shell 2150, however, in some embodiments the plasma cutting supports 1120 and/or the robotic cutting apparatus 1130 may be able to be moved and/or used with multiple seamed shells 2150 (e.g., as illustrated in FIG. 10B).

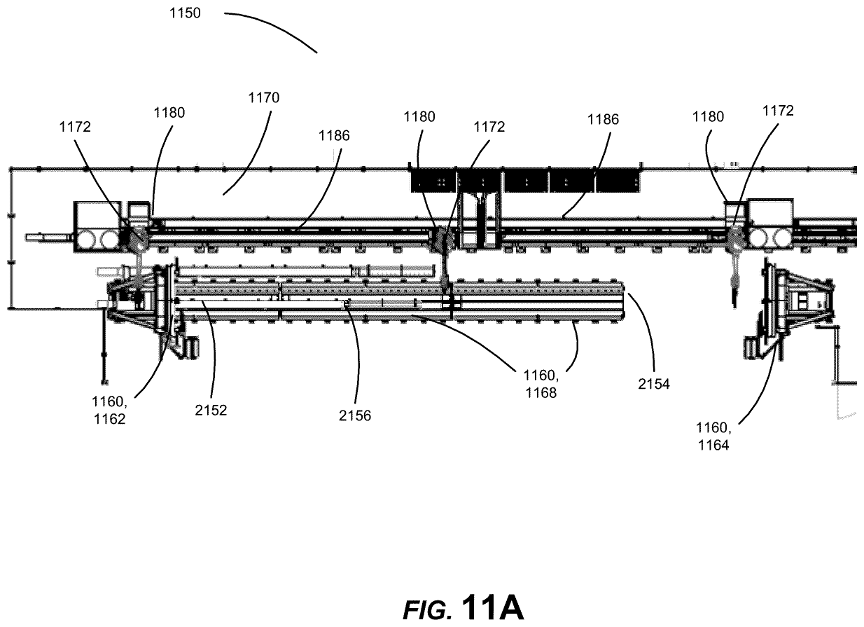

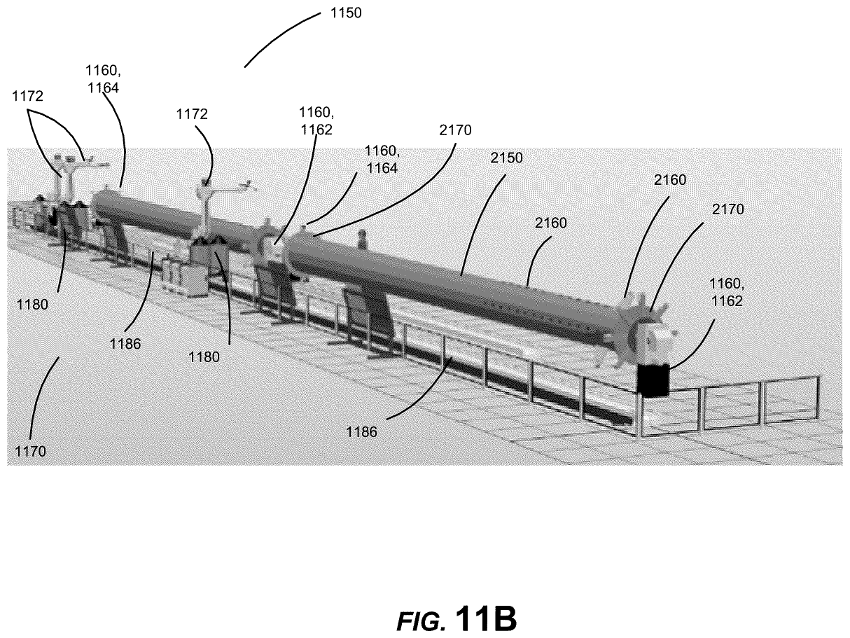

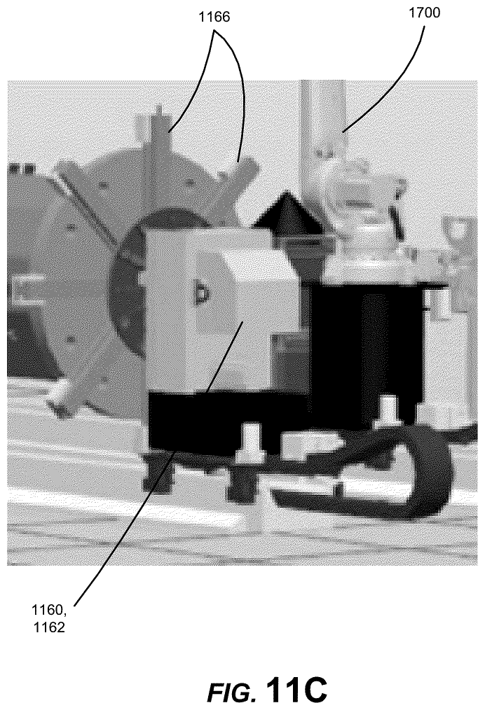

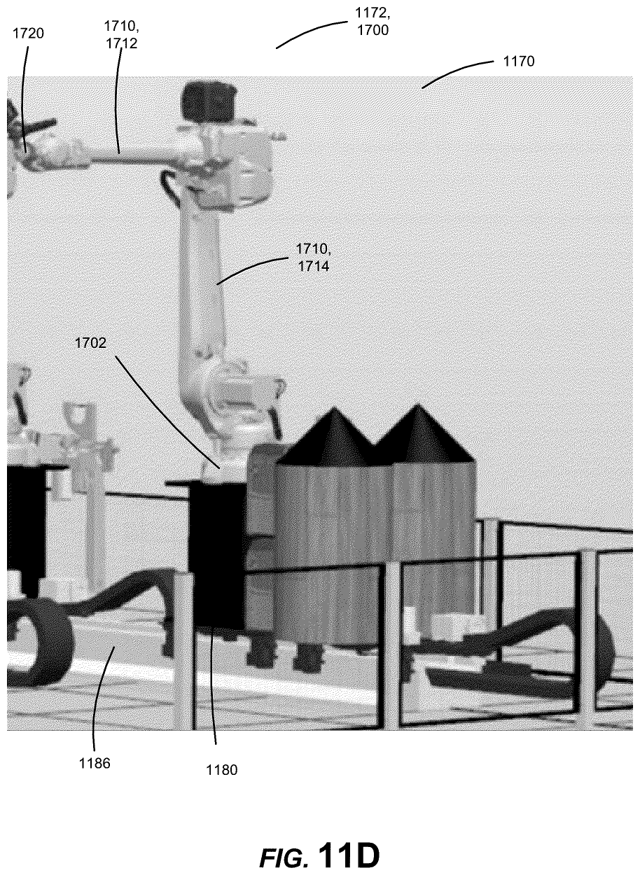

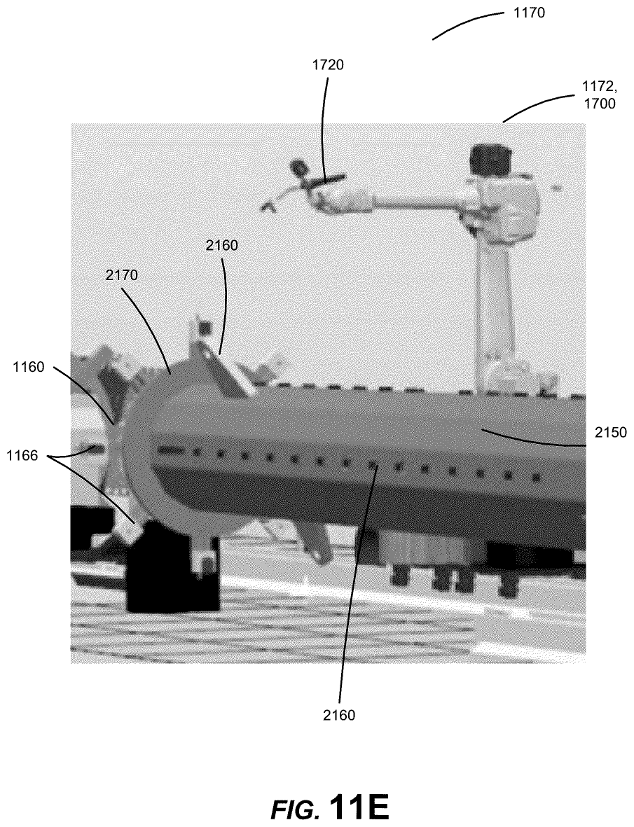

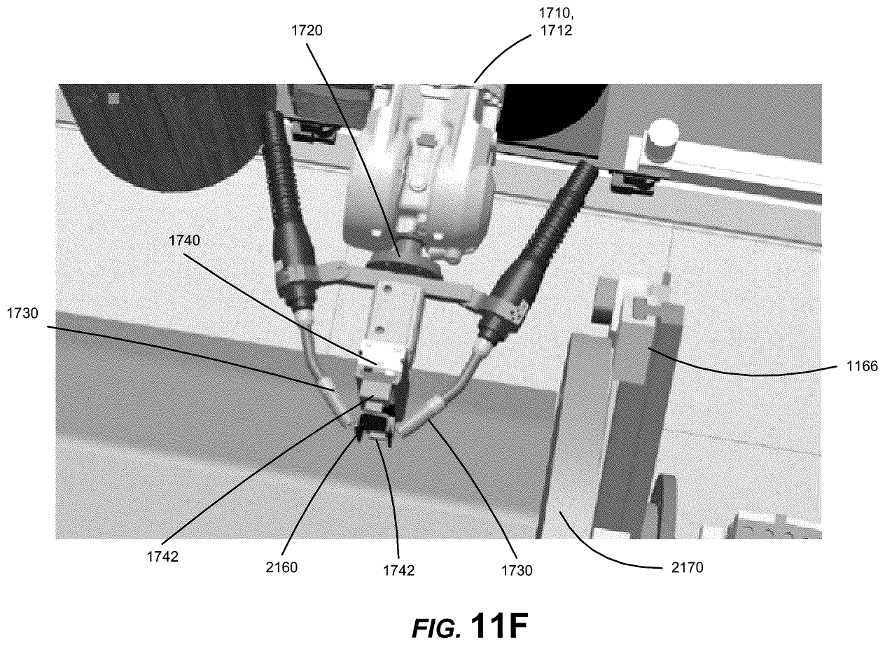

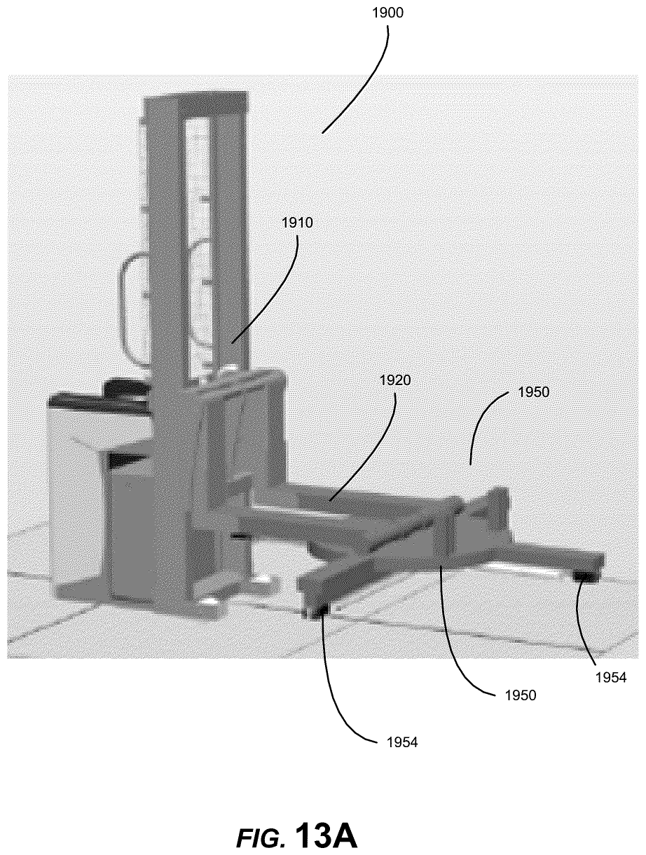

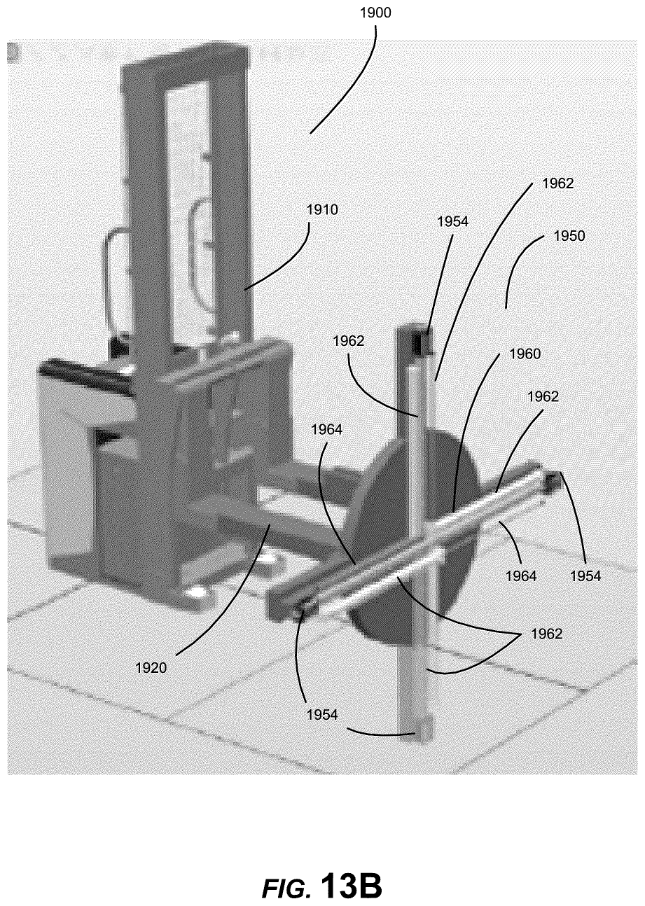

In some embodiments the one or more component assembly cells 1100 may also comprise a component welding apparatus 1150 that is used for welding components 2160 (e.g., flanges, vangs, vang supports, clamps, or the like) onto the seamed shells 2150 to form the assembled poles 2200. The flanges 2170 that are welded onto the seamed poles 2150 may be used for operatively coupling poles to each other to form the assembled towers 2300 (e.g., transmission tower, or the like), and/or used as the base (e.g., on a bottom pole) for attachment to anchors in the ground. As illustrated in FIGS. 11A through 11F, the component welding apparatus 1150 may be utilized by allowing a pole handling apparatus 800 (e.g., an overhead crane, forklift, or the like) to maneuver one or more flanges 2170 (e.g., a base plate flange 2172 for the pole, intermediate flange 2174, a top plate flange, or the like for the seamed pole 2150) into place on flange supports 1160, such as a flange headstock supports 1162, a flange tailstock supports 1164. In some embodiments, the flanges 2170 may be moved into place though the use of a flange transport apparatus 1900 (as will be described in further detail with respect to FIGS. 13A and 13B). The flange supports 1160 may be support structures that hold the flanges 2170 in place and/or align the flanges 2170 with respect to the seamed shells 2150 for welding the ends 2152, 2154 of the seamed shells 2150 to the flanges 2170. As illustrated in FIG. 11C, the flange supports 1160 may have a plurality of finger clamps 1166 (e.g., a static finger with a movable clamp), which may be adjustable in order to hold the edge of the flanges 2170. Additionally, or alternatively, the flange supports 1160 may be operatively coupled to an inner edge of the flanges 2170 (e.g., in a central aperture, to the extent there is one, within the flanges 2170). Additionally, or alternatively the flange supports 1160 may be operatively coupled to the bolt pattern within the flange 2170 that is used for operatively coupling two assembled poles portions 2200 together.

Before, during, or after the flanges 2170 are operatively coupled to the flange supports 1160, the seamed poles 2150 may also be transported to one or more component welding cells having one or more component welding apparatuses 1150 through the use of a pole handling apparatus 800 (e.g., an overhead crane, a forklift, table with rollers, conveyor, or the like). The seamed shells 2150 may be centered between the flange supports 1160 and between the one or more flanges 2170 (e.g., the base plate flange, intermediate flanges, the top plate flange, or the like). In some embodiments, the seamed shell 2150 is partially operatively coupled to one or more flanges 2170 automatically or manually (e.g., using tack welding, or the like), in order to adequately support the weight of the seamed shell 2150 before final assembly to the one or more flanges. Alternatively, or additionally, other supports, similar to or the same as the plasma cutting supports 1120, may be utilized to support the seamed shell 2150 between the flanges 2170.

The component welding apparatus 1150 may further comprise one or more robotic welding apparatuses 1170 (otherwise described as automated welding apparatuses 1170) comprising one or more welding robots 1172, one or more welding robot carriages 1180 and/or one or more welding robot tracks 1186. Each welding robot 1172 may be operatively coupled to a welding carriage 1180 and each welding carriage 1180 may move along the track 1186. As previously described herein with respect to the other automated apparatuses, the welding carriage 1180 may move with respect to the track 1186 through the use of a drive apparatus having a drive (e.g., motor, hydraulic, pneumatic, or the like), wheels, cables, chains, gears, belts, or the like. The one or more welding robots 1172 may be moved independently with respect to each other based on commands from the controller 1550, as will be described in further detail herein. As will be described in further detail below, the one or more welding robots 1172 may only weld; however, in other embodiments, the one or more welding robots 1172 may be a holding and/or welding robot 1174. In still other embodiments the component welding apparatus 1150 may have a component holding apparatus that uses automated robots, carriages, and/or tracks to hold the pole components 2160 in place while the automated welding apparatus 1170 welds the components 2160 to the seamed shell 2150. The component holding apparatus may use the same tracks or different tracks that are used by the automated welding apparatus 1170.

Within the one or more welding cells, the component welding apparatus 1150 may utilize one or more pre-heaters in order to pre-heat the one or more flanges 2170 and/or ends 2152, 2154 of the seamed shells 2150 to improve the welding operation. When the pre-heating is completed, the one or more automated welding apparatuses 1170 move the one or more robots 1172 into place adjacent the one or more flanges 2170 (e.g., adjacent a base flange, an intermediate flange, and/or a top flange) to weld the one or more flanges 2170 to the seamed shell (e.g., in one or more welding passes). Moreover, in some embodiments, the flange supports 1160 may be rotated (e.g., using a drive, such as a motor, or the like, gears, belts, chains, bands, or the like) in order to aid the automated welding apparatus 1170 in welding the flanges 2170 to the seamed pole 2150. For example, circumferential welds may be formed by rotating the seamed shells 2150 and/or one or more flanges 2170 as the end effector of the welding robot welds the flange 2170 to the end of the seamed shell 2150. Additionally, or alternatively, the welding robots 1172 may move in order to make at least a portion of the weld (e.g., circumferential weld) between the flanges 2170 and the ends of the seamed shell 2150.

After the circumferential welding of the flanges 2170 to the seamed shell 2150, a holding and/or welding robot 1174 (e.g., a stationary robot, a moveable robot that may move the same or similar way as the welding robots 1172) may be utilized in order to hold and weld (e.g., within one or more apertures, on the surface of the seamed shell 2150, or the like) other components 2160 (e.g., vangs, vang supports, clips, arms, arm supports, or the like) to the seamed shell 2150. It should be understood that a holding and/or welding robot 1174 may be used, as illustrated in FIG. 11F, which is able to pick one or more components 2160 (e.g., clip, support, arm support, arm flange, nut, fastener, or the like), move the one or more components 2160 to a location on the seamed shell 2150, and weld the one or more components to the seamed shell 2150. Alternatively, the holding and/or welding robot 1174 may be holding robot that only holds the component 2160 to the seamed shell 2150, while the same or different welding robots 1172 (e.g., the same or different robots that performed the flange welding) may weld the one or more components 2160 to the seamed shell 2150. After the completion of the welding, the robots 1172, 1174 may move to other stations to perform additional welding of components 2160 on other seamed shells 2150 (e.g., while the original seamed shell is moved after welding) and/or the pole handling apparatus 800 may be used to move the assembled pole 2200 (e.g., single pole, pole portion, or the like) to another cell for additional processing.

It should be understood that the same or different types of automated robots may be used for making the seam welds, flange welds, and/or component welds and/or for holding components, or the like. However, as illustrated at least in FIGS. 11D through 11F, the automated robots 1700 may include one or more moveable arms 1710. For example, in some embodiments a first arm 1712 is operatively coupled to a second arm 1714, and the second arm is operatively coupled to a base 1702, as shown in FIG. 11D. In other embodiments, a robot 1700 having more arms may be utilized. An end effector 1720 may be operatively coupled to the first arm 1712 for movement with respect to the first arm 1712. The end effector 1720 may comprise one or more welding tips 1730 having a power source, welding wire feed, or the like. In some embodiments when the robot 1700 is able to pick and hold a component, the end effector 1720 may comprise a gripping hand 1740 having one or more articulating fingers 1742 that are able to move (e.g., spread apart and/or close together) in order to grip a component. As such, in some embodiments the second arm 1714 may be able to spin and rotate with respect to the base 1702, the first arm 1712 may be able to spin and rotate with respect to the second arm 1714, and/or the end effector 1720 may be able to spin and rotate with respect to the first arm 1714. While a particular type of robot 1700 is illustrated in the figures, it should be understood that different types of robots 1700 may be utilized in order to perform the functions described herein. For example, the robots may move along a support rod, which is able rotate and move with respect to one or more other support rods in multiple directions. As such, in some embodiments the type of robotic movement is not limited to the specific robots described herein.

After seam welding the seamed shell 2150, straightening, trimming, fit-up, and/or component assembly, the pole handling apparatus 800 may transport the assembled pole 2200 (e.g., pole portion, or the like) to a slip joint (e.g., repair) cell 1200 and/or inspection cell 1300. The slip joint cell 1200 may be configured to weld the inside of the poles 2200. In some embodiments, the slip joint cell 1200 may comprise automated sub arc equipment used to weld the inside of the pole 2200. Moreover, the slip joint cell 1200 may be utilized to make repairs to any other welds on the pole 2200 (e.g., in the seam welds, component welds, or the like). The inspection cell 1300 may be utilized during different steps of the process; however, in some embodiments a final inspection cell 1300 may be utilized to perform a final inspection of the pole 2200 before final processing, packaging, and/or shipping. During final inspection manual inspection and/or automatic inspection using sensors, may be performed in order to identify any potential issues with the pole 2200 that may require repair (e.g., rework, or the like). If any issues are found, the pole 2200 may be repaired in the inspection cell 1300 and/or may be transported by the pole handling apparatus 800 to other cells and/or stations to make the repairs.

Should the pole 2200 pass inspection, the pole 2200 may be transported to one or more other locations (e.g., cells, stations, or the like) for additional processing. For example, the pole 2200 may be sent for shot blasting, coating (e.g., corrocote, galvanizing, or the like), and/or packaging. Any poles 2200 that do not require shot blasting or coating may be packaged and staged for shipping. Any pole 2200 that requires galvanizing shall be shot blasted before shipping. Shot blasting may be used to blast the pole 2200 to achieve a uniformed finish. Corrocote is a protective coating that may be applied to embedded poles. The corrocote is a two-part polyurethane that provides a barrier to corrosive soils. During coating (e.g., with corrocote, or the like) the poles 2200 may be sprayed with an industrial sprayer. Alternatively, during galvanizing the pole 2200 may be sprayed, dipped into a bath, such as a zinc coating bath, or the like. After shot blasting and/or coating, the pole 2200 will be packaged for shipping.

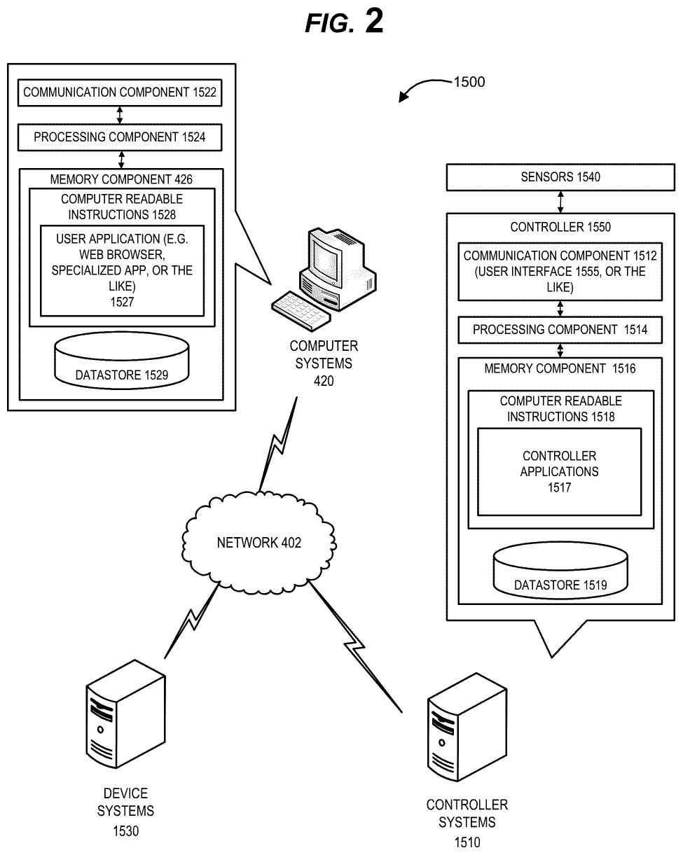

It should be understood that while the automated robots and/or various supports (e.g., supports for the shells, seamed shells, assembled poles, or the like) are generally discussed as being movable based on carriages, tracks, a drive assembly, or the like, these apparatuses may have independent drive apparatuses (e.g., wheels, motors, or the like) that allow the robots and/or supports to move independent of a track, such as within a geo-fenced area, within markings on the ground, walls, supports, or the like, within sensors (e.g., tags, communication devices, or the like). In still other embodiments, the robots and/or supports may be able to move between apparatuses within a cell or between cells within the facility. As such, while the robots and/or supports that are used to form the shells may be described as moving with respect to a track, these apparatuses may be able to move where needed based on the controller 1550 directing the movement of supports and/or robots (or components thereof). For example, more robots may be required to complete more welds on one pole than another pole 2200. As such, the robots may be deployed as needed. Additionally, or alternatively, instead of moving shaped shells 2100, seamed shells 2150, and/or poles 2200 through the use of cranes, rolling tables, or the like, the supports that are attached thereto may be able to move the shaped shells 2100, seamed shells 2150, and/or poles 2200 between different apparatuses and/or between cells or stations within the facility. Consequently, regardless of how the robots, supports, rollers, or other automated features of the facility move, these apparatuses may be moved by one or more controllers 1550 through the use of the device systems 1530, as will be discussed with respect to FIG. 2.

As described herein, in some embodiments, the flanges 2170 may be moved from a manufacturing station to the component welding apparatus 1150, and in particular, to the flange supports 1160 thereof, through the use of a flange transport apparatus 1900. The flange transport apparatus 1900 may be operatively coupled to a forklift, or other machinery that allows for the securing, transport, maneuvering, or the like of the flanges 2170 for assembly on the flange supports 1160. As illustrated in FIGS. 13A and 13B, the flange transport apparatus 1900 may have a flange transport lift 1910 (e.g., drive, supports, tracks, chains, belts, cables, pulleys, or the like) that allows for the vertical and/or rotational movement of one or more flange transport arms 1920. The flange transport arm(s) 1920 (e.g., first and second arms) may be operatively coupled to a flange gripper 1950, which may rotate with respect to the flange transport arms 1920. As such, the flange transport apparatus 1900, in particular the flange gripper 1950, may be used to pick up a flange 2170 (e.g., on the ground, on a table, on a rack—in any orientation, such as horizontal, vertical, or at an angle, or the like), and rotate the flange 2170 to another position (e.g., generally vertical, generally horizontal with respect to the ground, or the like, as illustrated in FIG. 13B) for transport and/or assembly to the flange supports 1160. In some embodiments, the flange gripper 1950 may be the same as or similar to the flange supports 1160 (or vice versa), such as the finger clamps 1166. As such, the flange gripper 1950 may have one or more flange support members (e.g., a plate, fingers 1952, and/or the like), one or more clamps 1954, and/or one or more drive assemblies 1960 that are used move the one or more clamps 1954 with respect to the one or more support members. The one or more drive assemblies 1960 may include a drive 1962 (e.g., actuator, motor, hydraulic, pneumatic, or the like) that is operatively coupled to the one or more clamps 1954, through the use of one more actuating members 1964 (e.g., flexible members, such as wires, ropes, chains, belts, cables, or the like, and/or rigid members, such as augers, screws, arms, rods, linkages, or the like) that are moved (e.g., pulled, pushed, rotated, or the like) to extend or retract the clamps 1954. In some embodiments, the one or more clamps 1954 may be moved independently, or two or more clamps 1954 may move together (e.g., opposing clamps 1954, all clamps 1954, or the like) in order to grip the edge of the flanges 2170 at the same time. While a specific configuration is illustrated in FIGS. 13A and 13B, it should be understood that other mechanisms, or combinations thereof, may be used to grip the flanges 2170 for transport to the flange supports 1160 for assembly to the flange supports 1160.

In some embodiments, the flange supports 1160 (e.g., fingers 1166, or the like) may be able to rotate and/or the flange gripper 1950 may be able to rotate to allow the flange supports 1160 and/or the flange gripper 1950 to align. As such, the flange support fingers 1166 and/or clamps thereof may be offset with the flange gripper fingers 1952 and/or the clamps 1954 thereof, so that the clamps of both may be moveable (and not interfere with each other) when transferring the flanges 2170 from the flange transport apparatus 1900 to the flange supports 1160.

FIG. 2 illustrates a schematic view of a network diagram, in accordance with embodiments of the invention, for operating the pole manufacturing line 10, and/or the various apparatuses, assemblies, and/or devices thereof. As such, it should be understood that the operation of the pole manufacturing line 10, including the blank handling apparatus 100, the blank cutting apparatus 200, the rotation apparatus 300, the shaping apparatus 400, the shell handling apparatus 500, the seam assembly apparatus 700, the pole handling apparatus 800, and/or the equipment within the one or more cells (e.g., the straightening cell 900, the trim cell 1000, the component assembly cell 1100, including the cutting apparatus 1110 and the component welding apparatus 1150, the slip-joint cell 1200, the inspection cell 1300, and/or the equipment for shot blasting, coating, and/or packaging), and/or the devices thereof (e.g., robots, carriages, drives, weld feeders, weld tip cleaners, tables, cranes, lifts, conveyors, rollers, or the like), are controlled by one or more programmable controllers 1550, which may communicate with other systems within or outside of a facility. As such, FIG. 2 illustrates a pole manufacturing system 1500, in accordance with embodiments of the present disclosure. As illustrated in FIG. 2, one or more controller systems 1510 are operatively coupled, via a network 1502, to one or more user computer systems 1520, one or more device systems 1530 (e.g., systems that control the robots, supports, carriages, drives, weld feeders, weld tip cleaners, tables, cranes, lifts, conveyors, rollers, drives, or the like of the pole manufacturing line 10), and/or one or more other systems (not illustrated). In this way, the controller systems 1510 of the pole manufacturing line 10 may communicate with one or more device systems 1530 for forming the material blanks 2020, shell blanks 2050, shaped shells 2100, seamed shells 2150, and/or assembled poles 2200, as described herein. The controller systems 1510 may communicate with user computer systems 1520 to allow the users of the user computer systems 1520 to monitor and/or remotely control the pole manufacturing line 10. Moreover, the controller systems 1510 may communicate with other systems, such as other systems of other machinery in the facility and/or other systems outside of the facility (e.g., ordering systems, third party systems, or the like) to determine what material blanks 2020, shell blanks 2050, shaped shells 2100, seamed shells 2150, assembled poles 2200, pole components 2160, and/or pole characteristics are needed to be produced within the pole manufacturing line 10 and/or provided by material supply systems and/or component supply systems that provide material blanks 2020 and/or additional components for the pole 2200. The communications may occur over a network 1502, as will be described in further detail herein.

The network 1502 may be a global area network (GAN), such as the Internet, a wide area network (WAN), a local area network (LAN), or any other type of network or combination of networks. The network 1502 may provide for wireline, wireless, or a combination of wireline and wireless communication between systems, services, components, and/or devices on the network 1502.

As illustrated in FIG. 2, the one or more controller systems 1510 may comprise a controller 1550 that may generally comprise one or more communication components 1512 (otherwise described as communication devices), one or more processing components 1514 (otherwise described as a processor), and one or more memory components 1516 (otherwise described as a memory). The one or more processing components 1514 are operatively coupled to the one or more communication components 1512, and the one or more memory components 1516. As used herein, the term “processing component” generally includes circuitry used for implementing the communication and/or logic functions of a particular system. For example, a processing component may include a digital signal processor component, a microprocessor component, and various analog-to-digital converters, digital-to-analog converters, and other support circuits and/or combinations of the foregoing. Control and signal processing functions of the system are allocated between these processing components according to their respective capabilities. The one or more processing components may include functionality to operate one or more software programs based on computer-readable instructions thereof, which may be stored in the one or more memory components.

The controller 1550 components, such as the one or more communication components 1512, may be operatively coupled to the one or more sensors 1540 (e.g., safety sensors, supply sensors, location sensors, material sensors, or the like), as previously discussed herein, located within the pole manufacturing line 10.

The one or more processing components 1514 use the one or more communication components 1512 to communicate with the network 1502 and other components on the network 1502, such as, but not limited to, the components of the one or more user computer systems 1520, the one or more device systems 1530, and/or the one or more other systems (not illustrated). As such, the one or more communication components 1512 generally comprise a wireless transceiver, modem, server, electrical connection, electrical circuit, or other component for communicating with other components on the network 1502. The one or more communication components 1512 may further include an interface that accepts one or more network interface cards, ports for connection of network components, Universal Serial Bus (USB) connectors, or the like. Moreover, the one or more communication components 1512 may include a keypad, keyboard, touchscreen, touchpad, microphone, mouse, joystick, other pointer component, button, soft key, and/or other input/output component(s) for communicating with the users. In some embodiments, as described herein, the one or more communication components 1512 may comprise a user interface, such as a graphical user interface 1555 that allows a user to control and/or monitor the operation of the pole manufacturing line 10.

As further illustrated in FIG. 2, the one or more controller systems 1510 comprise computer-readable instructions 1518 stored in the one or more memory components 1516, which in some embodiments include the computer-readable instructions 1518 of the one or more controller applications 1517 (e.g., used to operate the pole manufacturing line 10 and/or the apparatuses, assemblies, and/or devices thereof, or the like). In some embodiments, the one or more memory components 1516 include one or more data stores 1519 for storing data related to the pole manufacturing apparatus 10, including, but not limited to, data created, accessed, and/or used by the one or more controller systems 1510 to operate the pole manufacturing line 10 in order to form the material blanks 2020, shell blanks 2050, shaped shells 2100, seamed shells 2150, and/or assemble the shaped shells 2100 into the poles 2200 (e.g., in accordance with pole specifications that may be stored, to optimize the use of the apparatuses, assemblies, and/or devices within the apparatuses, or the like).

As illustrated in FIG. 2, users may communicate with each other over the network 1502 and the controller systems 1510, the device systems 1530, and/or other systems in order to control and/or monitor the various systems locally at the pole manufacturing line 10 and/or remotely away from the pole manufacturing line 10. Consequently, the one or more users may be assemblers, welders, employees, agents, representatives, officers, contractors, or the like of an organization operating the facility. The one or more user computer systems 1520 may be a desktop, laptop, tablet, mobile device (e.g., smartphone device, or other mobile device), or any other type of computer that generally comprises one or more communication components 1522, one or more processing components 1524, and one or more memory components 1526. In some embodiments, the one or more computer systems 1520 may be located upstream, within, or downstream of the pole manufacturing apparatus 10 and are used for pre-assembly and/or post-assembly inspections of the material blanks 2020, shell blanks 2050, shaped shells 2100, seamed shells 2150, and/or assembled poles 2200 (e.g., complete the welding, inspect welding, and/or the like).

The one or more processing components 1524 are operatively coupled to the one or more communication components 1522, and the one or more memory components 1526. The one or more processing components 1524 use the one or more communication components 1522 to communicate with the network 1502 and other components on the network 1502, such as, but not limited to, the one or more controller systems 1510, the one or more device systems 1530, and/or the other systems (not illustrated). As such, the one or more communication components 1522 generally comprise a wireless transceiver, modem, server, electrical connection, or other component for communicating with other components on the network 1502. The one or more communication components 1522 may further include an interface that accepts one or more network interface cards, ports for connection of network components, Universal Serial Bus (USB) connectors and the like. Moreover, the one or more communication components 1522 may include a keypad, keyboard, touchscreen, touchpad, microphone, mouse, joystick, other pointer component, button, soft key, and/or other input/output component(s) for communicating with the users. In some embodiments, the one or more communication components 1522 may comprise a user interface, such as a graphical user interface that allows a user to remotely control and/or monitor the operation of the pole manufacturing line 10.

As illustrated in FIG. 2, the one or more user computer systems 1520 may have computer-readable instructions 1528 stored in the one or more memory components 1526, which in some embodiments includes the computer-readable instructions 1528 for user applications 1527, such as dedicated applications (e.g., apps, applet, or the like), portions of dedicated applications, a web browser or other apps that allow access to applications located on other systems, or the like. In some embodiments, the one or more memory components 1526 include one or more data stores 1529 for storing data related to the one or more user computer systems 1520, including, but not limited to, data created, accessed, and/or used by the one or more user computer systems 1520. The user application 1527 may use the applications of the one or more controller systems 1510, the one or more device systems 1530, and/or one or more other systems (not illustrated) in order to communicate with other systems on the network 1502 and take various actions described herein (e.g., operation, use, monitoring, or the like of the pole manufacturing line 10).

Moreover, as illustrated in FIG. 2, the one or more device systems 1530 and/or other systems (not illustrated) have components the same as or similar to the components described with respect to the one or more controller systems 1510 and the one or more user computer systems 1520 (e.g., one or more communication components, one or more processing components, one or more sensors, one or more memory devices with computer-readable instructions of one or more product applications, one or more datastores, or the like). Thus, the one or more device systems 1530 communicate with the one or more controller systems 1510, the one or more user computer systems 1520, and/or one or more other systems in the same or similar way as previously described with respect to the one or more controller systems 1510, the one or more user computer systems 1520, and/or the one or more other systems. The one or more device systems 1530 may comprise the systems that operate the machines (e.g., robots, supports, carriages, actuators, drives, weld feeders, weld tip cleaners, tables, cranes, lifts, conveyor, rollers, or the like) of the pole manufacturing apparatus 10 that are used to form and/or assemble the blanks, shells and/or poles.

In some embodiments it should be understood that the controller 1550 may utilize machine learning supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

As will be appreciated by one of skill in the art in view of this disclosure, embodiments of the invention may be embodied as an apparatus, a system, computer program product, and/or other device, a method, or a combination of the foregoing. Accordingly, embodiments of the invention may take the form of an entirely hardware embodiment, an entirely software embodiment (including firmware, resident software, micro-code, or the like), or an embodiment combining software and hardware aspects that may generally be referred to herein as a system. Furthermore, embodiments of the invention may take the form of a computer program product comprising a computer-usable storage medium having computer-usable program code/computer-readable instructions embodied in the medium (e.g., a non-transitory medium, or the like).

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the invention may be written in an object oriented, scripted or unscripted programming language such as Java, Pearl, Python, Smalltalk, C++ or the like. However, the computer program code/computer-readable instructions for carrying out operations of the invention may also be written in conventional procedural programming languages, such as the “C” programming language or similar programming languages.

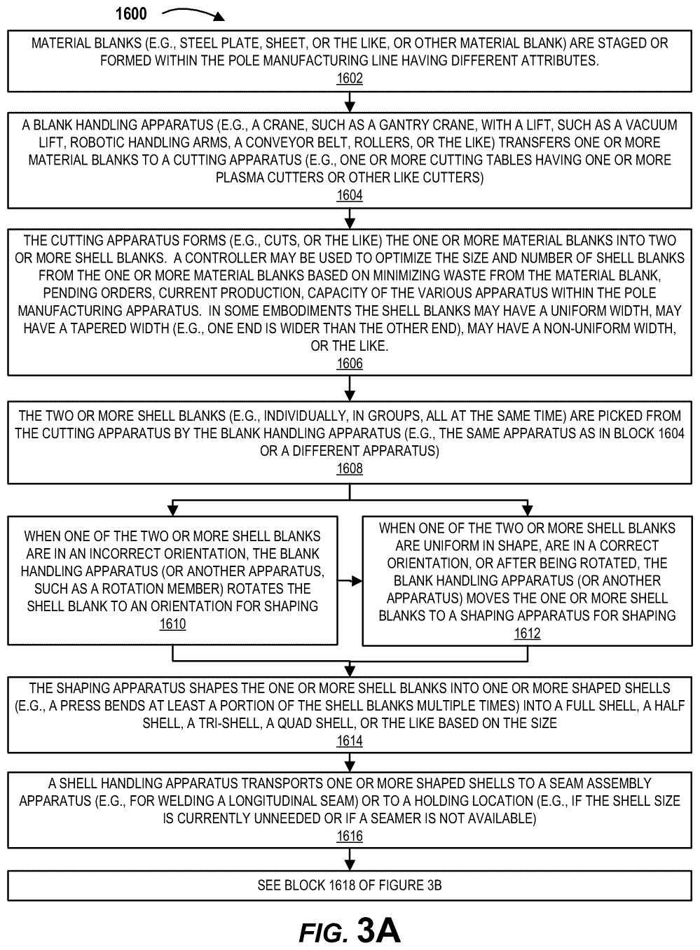

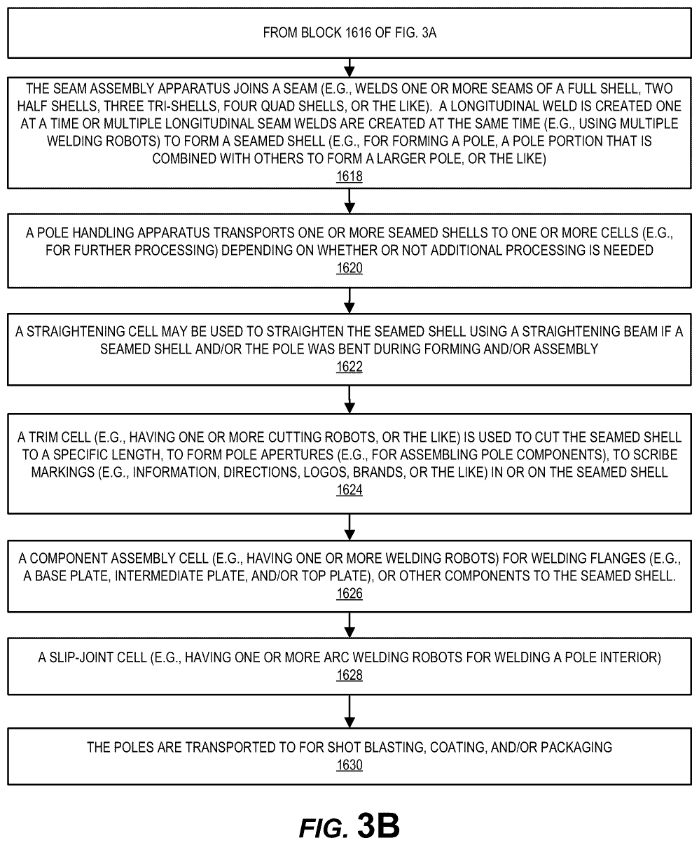

FIGS. 3A and 3B illustrate a process flow 1600 for assembling a pole 2200 using the pole manufacturing line 10 described herein. In some embodiments the pole 2200 may be used in the field, or the pole 2200 may be a pole portion (e.g., a first pole portion 2212, second pole portion 2214, third pole portion 2216, nth pole portion, or the like) that may be used for assembling a tower from multiple poles 2200, such as a transmission tower 2000, as illustrated in one embodiment in FIG. 12.

As illustrated by block 1602 of FIG. 3A, material blanks 2020 (e.g., steel material, such as a steel plate, steel sheet, or other like material as described herein) are staged within the pole manufacturing line 10. The material blanks 2020 may be formed outside of the pole manufacturing line 10 and delivered to the pole manufacturing line 10 for processing or may be formed within a material supply station 50, as previously discussed herein. For example, the material blanks 2020 may be stacked and/or may have different attributes in each stack of material blanks 2020. Additionally, or alternatively, the material blanks 2020 may be formed as needed from steel sheet coils 2010, from steel plates, or other materials. As such, the material blanks 2020 used to form the shell blanks 2050 may have different widths, lengths, thicknesses, material properties, or the like.

Block 1604 of FIG. 3A further illustrates that a blank handling apparatus 100, such as a material blank handling apparatus, may be used to pick a material blank 2020 from the material blank supply station 50. As previously descried herein, the controller 1550 may communicate with the blank handling apparatus 100 and/or sensors in order to direct the blank handling apparatus 100 to pick a particular material blank 2020 from a specific location, such as based on an attribute of the material blank 2020 (e.g., determined by a sensor, stored based on the locations of the material blanks, or the like). The controller 1550 may determine what material blank 2020 to select based on the work-in-process material located downstream and/or a queue of shell blanks 2050, shaped shells 2100, seamed shells 2150 and/or assembled poles 2200 that are scheduled for production. As such, the controller 1550 may be used to optimize the production flow in the pole manufacturing line 10. In some embodiments, the blank handling apparatus 100 is a crane and vacuum lift and/or a rolling table that transports (e.g., picks, moves, or the like) the material blank 2020 to the blank cutting apparatus 200.

FIG. 3A illustrates in block 1606 that the blank cutting apparatus 200 receives the material blank 2020 from the blank handling apparatus 100 and forms (e.g., cuts, or the like described herein) the material blank 2020 into one or more shell blanks 2050, and more particularly, into two or more shell blanks 2050. The controller 1550 may be utilized to optimize the size and number of shell blanks 2050 formed within the blank cutting apparatus 200 based on minimizing waste from the material blank 2020, pending orders in a queue, current products in production, capacity of the apparatuses, stations, and/or cells within the pole manufacturing line 10. The shell blanks 2050 may have tapered widths, and thus, may be formed in alternating patterns within the material blank 2020. As previously described herein, the blank cutting apparatus 200 may include one or more cutters (e.g., tables, plasma torches, CNC automation, or the like). As such, multiple material blanks 2020 may be cut on different plasma cutters at the same time, or otherwise, be in different stages of production (e.g., receiving a material blank 2020, while other tables or other parts of the table have material blanks 2020 being cut, shell blanks 2050 being removed after cutting, and/or scrap material being removed from the table).

Block 1608 of FIG. 3A illustrates that one or more shell blanks 2050, and preferably two or more shell blanks 2050 (e.g., individually, or in groups) are transported from the blank cutting apparatus 200. The shell blanks 2050 may be pick and moved by a blank handling apparatus, such as the material blank handling apparatus 100 discussed with respect to block 1604. However, in other embodiments the blank handling apparatus may be a shell blank handling apparatus 130 that is different than the material blank handling apparatus 100. The controller 1550 may be used, alone with sensors, in order to direct the blank handling apparatus 100 to transport different shell blanks 2050 based on the downstream needs, the size of the shell blanks 2050, the shell blanks 2050 that require rotating, or the like.

FIG. 3A further illustrates in blocks 1610 and 1612 that the material handling apparatus 100 may rotate a shell blank 2050 or transfer the shell blank 2050 to a rotation apparatus 300 when the shell blank 2050 is in the wrong orientation for shaping. It should be understood that when the shell blank 2050 is in the correct orientation, the shell blank has a uniform width (e.g., not tapered), or after the shell blank 2050 has been rotated into the proper orientation, it may be transported to a shaping apparatus 400. In particular, as illustrated in block 1610 when a shell blank 2050 is in an incorrect orientation, the blank handling apparatus 100 may rotate one or more shell blanks 2050 into a correct orientation (e.g., through rotation of one or more grippers, support members, the crane, or another component of the material handling apparatus). Alternatively, the blank handling apparatus 100, such as the crane, rolling table, or the like, delivers the shell blank 2050 that is in the incorrect orientation to a rotation apparatus 300, which rotates the shell blank 2050 into the correct orientation before it is delivered to the shaping apparatus 400.

As illustrated in block 1612 of FIG. 3A, when a shell blank 2050 of the one or more shell blanks 2050 is uniform in shape, is in the correct orientation, or after the shell blank 2050 is rotated into the correct position, the blank handling apparatus 100 moves the one or more shell blanks 2050 to a shaping apparatus 400. Moreover, the blank handling apparatus 100, at the direction of the controller 1550, may continuously (or at least intermittently) provide material blanks 2020 to the cutting apparatus 200 as the cutting is completed, the shell blanks 2050 are removed, the scrap material is removed, and/or the like.

In some embodiments, not specifically illustrated in FIGS. 3A and 3B, the shell blanks 2050 may be moved by the blanking handling apparatus 100 and/or the rotation apparatus 300 may be used to deliver the shell blanks 2050 to a holding station 600, such as shell blank holding apparatus 610, which is used to store the shell blanks 2050 in laterally and/or vertically spaced racks. As such, the controller 1550 may be used to pick various shell blanks 2050 as needed based on the production requirements and optimization of the apparatus within the pole manufacturing line 10.

As previously described herein, the shaping apparatus 400 may comprise of multiple shapers 402 (e.g., multiple presses, or other shapers) that may be able to shape different sized shell blanks 2050 or may be set up to shape specific sized shell blanks 2050. As such, the controller 1550 may direct the blank handling apparatus 100 to deliver the shell blanks 2050 to different presses with one or more the shaping apparatuses 400 based on the availability thereof, type of shaped shell 2100 that may be formed by the press, or the like. After the shell blanks 2050 are delivered to the shaping apparatus 400, as illustrated in block 1614 of FIG. 3A, the shaping apparatus 400 forms the different shaped shells 2100 (e.g., full-shell, half-shell, tri-shell, quad-shell, or the like). The shaping apparatus 400 may form the shaped shells 2100 at the direction of the controller 1550 by bending the shell blank 2050 at multiple locations as the shell blank 2050 is moved within the shaper 402, as previously described herein. The controller 1550 may be used to communicate with the shapers 402 in order to create the different types of shaped shells 2100 based on the size of the shell blanks 2050 and/or the need for different shaped shells 2100 downstream of the shaping apparatus 400.

Block 1616 of FIG. 3A further illustrates that after the shaped shells 2100 are formed, a shell handling apparatus 500 transports the one or more shaped shells 2100 to a seam assembly apparatus 700. The seam assembly apparatus 700 may comprise of multiple seam welding apparatuses 702 that create one or more longitudinal seam welds in the one or more shaped shells 2100 in order to form the seamed shells 2150, as previously described herein. The controller 1550 may direct the shell handling apparatus 500 to move the shaped shells 2100 to different seam welding apparatuses 702 based on the type of shaped shell 2100 (e.g., full, half, tri, quad, or the like) needed to form a specific pole 2200. As discussed herein, the shell handling apparatus 500 may comprise a rolling table that transports shaped shells 2100 to a holding station 600, such has the shaped shell holding apparatus 620 previously discussed herein, and/or to a seam welding apparatus 702 of the seam assembly apparatus 700 that is open and able to weld a seam for the various shaped shells 2100.

FIG. 3B further illustrates in block 1618 that the seam assembly apparatus 700 joins a seam in one or more shaped shells 2100. For example, one or more seams welds are formed within a full shell, two half shells, three tri-shell, four quad shells, or the like to form a seamed shell 2150. A seam weld may be formed one at a time, or multiple welds may be formed at the same time using one or more welding robots in order to form the seamed shell 2150, as previously discussed herein. The seamed shell 2150 formed by the seamer may be used as a single assembled pole 2200 or may be a pole portion 2200 that will be combined with other pole portions 2200 in the field to form a transmission pole tower 2000. The controller 1550 may direct the one or more seam welding apparatuses 702 to create one or more welds based on the types of shaped shells 2150 in the seam welding apparatus 702.

Block 1620 of FIG. 3B illustrates that a pole handling apparatus 800 transports one or more seamed shells 2150 to one or more cells for further processing. The pole handling apparatus 800 may be the same handling apparatus as the shell handling apparatus 500 or it may be a different handling apparatus. The pole handling apparatus 800 may comprise a rolling table, a conveyer apparatus, an overhead crane, or the like that moves the seamed shells 2150 to the one or more cells based on the particular seamed shells 2150, capacity within the cells, the poles in the queue based on customer orders, or the like.

FIG. 3B illustrates in block 1622 that in some embodiments the seamed shell 2150 is transported to a straightening cell 900 if the seamed shell 2150 and/or a shell thereof is bowed during the forming or assembly process. As described herein, the straightening cell may utilize a hydraulic straightening member to straighten the seamed shell 2150 and/or the pole 2200.

Block 1624 of FIG. 3B illustrates that in some embodiments the seamed shell 2150 is transported to a trim cell 1000. The trim cell 1000 may utilize one or more cutting robots to cut the pole to a specific length and/or set the diameter of the ends of the pole 2200, and/or for scribing markings on the pole (e.g., information, directions, logos, brands, or the like).

FIG. 3B further illustrates in block 1626 that a component assembly cell 1100 may receive the seamed shell 2150 in order to assemble various components to the seamed shell 2150. The component assembly cell 1100 may be used to fit-up the components to the seamed shell 2150 and/or to hold the components for assembly. For example, as previously discussed herein, the component assembly cell 1100 may comprise a cutting apparatus 1110 for chamfering the ends of the seamed shell 2150 and/or forming apertures in the seamed shell 2150 for assembly of other components. Additionally, or alternatively, the component assembly cell may comprise a component welding apparatus 1150 for welding components to the seamed shell 2150. As such, as previously described herein, the component assembly cell may include one or more cutting, welding, and/or component holding supports and/or robots for holding and welding the components 2160 (e.g., hardware, such as flanges 2170 and/or supports, such as clamps, clips, studs, bolts, nuts, members, or the like) to the seamed shell 2150. The assembled pole 2200 (e.g., pole, pole portion, or the like) may be ready for final processing after the components 2160 (e.g., flanges 2170 and/or other components) are assembled to the seamed shell 2150.

Block 1628 of FIG. 3B further illustrates that after assembly of the pole 2200, the pole 2200 may be sent to a slip-joint cell 1200 that may be used to weld the interior of the pole 2200. The slip-joint cell 1200 may use one or more arc welding robots to weld the interior of the pole 2200. This cell may also be used to repair other portions of the pole 2200 and/or the pole 2200 may be sent to other cells for additional processing, as previously described herein.

FIG. 3B further illustrates in block 1630 that the pole may be sent for shot blasting, coating (e.g., galvanizing, corrocote, or the like), and/or packaging.

The embodiments of pole manufacturing line 10, and apparatuses thereof, and the process of forming the material blanks 2020, the shell blanks 2050, the shaped shells 2100, the seamed shells 2150, preparing the seamed shells 2150 for components 2160, the components 2160 needed, and/or assembling the components 2160 to the shaped shells 2150 to form a pole 2200, as described herein, provides improvements over traditional pole manufacturing equipment and processing. Typical traditional processes require long lead times and space for storing material, cut material, shells, and partially assembled poles in order to fulfil customer orders. Typical traditional processes also require manual processes for forming and assembling the shells into the poles and assembling components thereto. The manual processes are prone to inefficiency and defects in the poles. The pole manufacturing line 10 of the present invention provides optimization of the manufacturing process that reduces waste (e.g., reduces scrap), improves lead times for manufacturing poles, reduces defects, creates repeatable poles, and/or provides other benefits over traditional processes.

In particular, optimization of the manufacturing process is provided through the use of the controller being able to determine the status of the products at each apparatus, the orders that are placed and when shipments are required, the time it takes for each apparatus to complete an operation depending on the attributes of the materials, the types of products each apparatus may be able to handle, the materials available to complete the orders, and/or the materials pre-formed in the holding stations that are available. As such, the controller may be able to optimize the manufacturing processes based on these parameters by determining the material blanks 2020, the shell blanks 2050, the shaped shells 2100, the seamed shells 2150, the seamed shells 2150 to be prepped for component 2160 assembly, the components 2160 needed for assembly, and/or the shaped shells 2150 to assemble the components 2160 in order to determine what to send to the next available apparatus in the manufacturing line 10. Moreover, waste is reduced because the shell blanks 2050 formed from the material blanks 2020 are optimized by maximizing what shell banks 2050 can be formed from the material blanks 2020 available, and moreover the automated welding reduces the amount of product that has to be scrapped due to improper welds. The lead times for specific poles 2200 may be reduced because of the optimization process, due to the ability to pre-form and/or store shell blanks 2050 and/or shaped shells 2100 in holding stations using vertically and laterally spaced racks, and/or being able to utilize multiple types of apparatus (e.g., single and/or multiple seam welding apparatuses, or the like) to process the same or different products. Moreover, the manufacturing line 10 reduces defects and creates repeatable poles 2200 because of the improved apparatuses used within manufacturing line 10. Finally, the manufacturing line 10 reduces costs because the poles 2200 can be manufactured more quickly, the apparatuses are more flexible in being able to produce multiple types of products, the number of manual operations are reduced, or the like.

Certain terminology is used herein for convenience only and is not to be taken as a limitation on the embodiments described. For example, words such as “proximal”, “distal”, “first”, “second”, “top”, “bottom”, “upper”, “lower”, “left”, “right”, “horizontal”, “vertical”, “upward”, “downward”, “parallel”, and/or “perpendicular” merely describe the configuration shown in the figures and/or from the reference point of an observer located at a particular location. Indeed, the referenced components may be oriented in any direction and the terminology, therefore, should be understood as encompassing such variations unless specified otherwise. Throughout this disclosure, where a process or method is shown or described, the method may be performed in any order or simultaneously, unless it is clear from the context that the method depends on certain actions being performed first.

Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” may mean “one or more.”

It should be understood that “operatively coupled,” or other like terms such as “secured,” “connected,” or the like, when used herein, means that the components, devices, members, or the like may be formed integrally with each other, or may be formed separately and coupled together. Furthermore, “operatively coupled”, “secured,” “connected,” or the like means that the components may be formed directly to each other, or to each other with one or more components located between the components that are operatively coupled, scurred, or connected together. Furthermore, “operatively coupled”, “secured,” “connected,” or the like may mean that the components are detachable from each other, or that they are permanently coupled, secured, or connected together.

Specific embodiments of the invention are described herein. Many modifications and other embodiments of the invention set forth herein will come to mind to one skilled in the art to which the invention pertains, having the benefit of the teachings presented in the foregoing descriptions and the associated drawings. Therefore, it is to be understood that the invention is not to be limited to the specific embodiments disclosed and that modifications and other embodiments and combinations of embodiments are intended to be included within the scope of the appended claims. Although specific terms are employed herein, they are used in a generic and descriptive sense only and not for purposes of limitation.

What is claimed is:

1. A pole manufacturing line for forming poles, the pole manufacturing line comprising:
a shell forming apparatus comprising:
a blank cutting apparatus, wherein the blank cutting apparatus forms a plurality of shell blanks from a material blank;
a shaping apparatus, wherein the shaping apparatus forms a shaped shell from a shell blank; and
a shell assembly apparatus comprising:
a seam welding apparatus, wherein the seam welding apparatus welds one or more seams of one or more shaped shells to form a seamed shell;
a seamed shell cutting apparatus, wherein the seamed shell cutting apparatus forms one or more apertures in the seamed shell or forms one or more ends of the seamed shell; and
a component welding apparatus, wherein the component welding apparatus welds one or more components to the seamed shell to form a pole.

2. The pole manufacturing line of claim 1, wherein the pole tapers from a wide end to a narrow end, wherein the pole is at least a portion of a transmission pole, and wherein one or more poles are used to form the transmission pole.

3. The pole manufacturing line of claim 1, wherein the blank cutting apparatus forms two or more shell blanks from the material blank, and wherein at least a first shell blank is in a first orientation that is in an opposite orientation from at least a second shell blank in a second orientation.

4. The pole manufacturing line of claim 3, wherein the shell forming apparatus further comprises:
a blank handling apparatus, wherein the blank handling apparatus is configured to rotate the first shell blank from the first orientation to the second orientation, wherein the second orientation locates a wide end and a narrow end of the shell blank for shaping by the shaping apparatus.

5. The pole manufacturing line of claim 4, wherein the blank handling apparatus comprises:
a rotation apparatus comprising:
a rotator table;
a rotator carriage operatively coupled to the rotator table; and
one or more rotator drive apparatuses operatively coupled to the rotator carriage;
wherein the one or more rotator drive apparatuses allow the rotator table to move laterally to receive or deliver the plurality of shell blanks in different lateral positions;
wherein the one or more rotator drive apparatuses allow the rotator table to move vertically to receive or deliver the plurality of shell blanks in different vertical positions; and
wherein the one or more rotator drive apparatuses allow the rotator table to rotate the first shell blank in the first orientation to the second orientation.

6. The pole manufacturing line of claim 1, wherein the shell forming apparatus further comprises:
a shell blank holding apparatus comprising:
a plurality of racks having two or more laterally spaced racks and two or more vertically spaced racks; and
wherein the shell blanks having different attributes are stored in the plurality of racks.

7. The pole manufacturing line of claim 6, wherein the shell blank holding apparatus further comprises:
a feeder apparatus comprising:
a feeder table;
a feeder carriage; and
one or more feeder drive apparatuses operatively coupled to the feeder carriage;
wherein the one or more feeder drive apparatuses allow the feeder table to move laterally to receive or deliver the plurality of shell blanks in different lateral positions; and
wherein the one or more feeder drive apparatuses allow the feeder table to move vertically to receive or deliver the plurality of shell blanks in different vertical positions.

8. The pole manufacturing line of claim 1, wherein the shaping apparatus comprises:
a plurality of shapers;
wherein the plurality of shapers operate independently or jointly to shape the plurality of shell blanks of different sizes into shaped shells of different sizes.

9. The pole manufacturing line of claim 8, wherein the shaping apparatus further comprises:
one or more sensors; and
one or more shell blank handling apparatuses operatively coupled to the sensors;
wherein the one or more shell blank handling apparatuses position the shell blank with respect to the plurality of shapers based on the information from the one or more sensors captured from a shape of the shell blank or markings on the shell blank.

10. The pole manufacturing line of claim 1, wherein the shell assembly apparatus further comprises:
a shaped shell holding apparatus comprising:
a plurality of racks having two or more laterally spaced racks and two or more vertically spaced racks; and
wherein the plurality of shaped shells having different attributes are stored in the plurality of racks.

11. The pole manufacturing line of claim 1, wherein the seam welding apparatus comprises:
an end support configured to be operatively coupled with the one or more shaped shells;
an automated welder apparatus configured to weld the one or more seams of the one or more shaped shells;
wherein the end support pulls or pushes the one or more shaped shells past the automated welder.

12. The pole manufacturing line of claim 1, wherein the seam welding apparatus comprises:
one or more shell supports configured to support two or more shaped shells;
one or more shell mating apparatuses, the one or more shell mating apparatuses comprising:
one or more actuating mating members; and
one or more mating drive apparatuses operatively coupled to the one or more actuating mating members;
wherein the one or more actuating mating members are configured to move at least a first shaped shell to mate with at least a second shaped shell before seam welding;
one or more automated welders configured to weld the one or more seams of the two or more shaped shells.

13. The pole manufacturing line of claim 1, wherein the seamed shell cutting apparatus comprises:
one or more shell cutting supports configured to support the seamed shell;
one or more shell cutting tracks;
one or more shell cutting carriages operatively coupled to the one or more shell cutting tracks; and
one or more shell cutting robots operatively coupled to the one or more shell cutting carriages;
wherein the one or more cutting robots are moveable to form the one or more apertures in the seamed shell or form the one or more ends of the seamed shell.

14. The pole manufacturing line claim 1, wherein the component welding apparatus comprises:
one or more flange supports configured to support one or more flanges;
one or more component welding tracks;
one or more component welding carriages operatively coupled to the one or more component welding tracks; and
one or more component welding robots operatively coupled to the one or more component welding carriages;
wherein the one or more component welding robots are moveable to weld the one or more flanges to the one or more ends of the seamed shell.

15. The pole manufacturing line of claim 14, wherein the component welding apparatus further comprises:
one or more holding robots operatively coupled to the one or more shell welding carriages:
wherein the one or more holding robots hold pole components to the seamed shell while the one or more shell welding robots weld the components to the seamed shell.

16. The pole manufacturing line of claim 14, wherein the flange supports comprise:
one or more flange members;
a plurality of clamps operatively coupled to the one or more flange members;
one or more clamp drive apparatuses operatively coupled to the one or more flange members and the plurality of clamps;
wherein the plurality of clamps extend and retract to hold a plurality of flanges having different sizes.

17. The pole manufacturing line of claim 1, further comprising:
a controller system comprising:
one or more memories storing computer-readable code; and
one or more processors operatively coupled to the one or more memories, wherein when executed the computer-readable code is configured to cause the one or more processors to:
communicate with the blank cutting apparatus to form two or more shell blanks having one or more attributes and send the two or more blanks to a holding apparatus;
communicate with the shaping apparatus to form the shaped shell from the shell blank;
communicate with the seam welding apparatus to form one or more seam welds in the one or more seams of the one or more shaped shells;
communicate with the shell cutting apparatus to form the one or more apertures or the one or more ends of the seamed shell;
communicate with the component welding apparatus to weld the one or more components to the seamed shell to form the pole.

18. The pole manufacturing line of claim 18, wherein the controller system is configured to control the shell forming apparatus and the shell assembly apparatus to optimize pole manufacturing to reduce waste and improve lead times.

19. A method of forming poles using a pole manufacturing line, comprising:
forming a plurality of shell blanks from material blanks using a blank cutting apparatus;
forming a plurality of shaped shells from the plurality of shell blanks using a shaping apparatus;
welding seams of a plurality of single shaped shells or a plurality of multiple shaped shells to form a plurality of seamed shells using a seam welding apparatus;
forming a plurality of apertures or a plurality of ends on the plurality of seamed shells using a cutting apparatus; and
welding a plurality of components to the plurality of shaped shells using a component welding apparatus.
